(19) United States
(12) Patent Application Publication
(10) Pub. No.: US 2025/0024337 A1
(43) Pub. Date: Jan. 16, 2025

(54) PUCCH SSCELL SWITCHING CONFIGURATION AND ACTIVATION FOR UCI FEEDBACK

(71) Applicant: Radisys Corporation, Hillsboro, OR (US)

(72) Inventors: Nalinikanta DASH, Puri (IN); Rajendra Prasad KODAYPAK, Hillsboro, OR (US)

(21) Appl. No.: 18/352,925

(22) Filed: Jul. 14, 2023

(51) Int. Cl. H04W 36/06; H04W 36/00

(52) U.S. Cl. CPC H04W 36/06; H04W 36/0072

(57) ABSTRACT

A gNB establishes a list of PUCCH sSCells for PUCCH sSCell switching by receiving UE capability information from a UE during an initial registration procedure, the UE capability information indicating whether the UE supports PUCCH cell switching; determining whether the UE supports PUCCH cell switching; and transmitting an RRC configuration including a PhysicalCellGroupConfig information element, the PhysicalCellGroupConfig information element including a sequence of pucch-sSCell information elements to configure multiple cells as PUCCH sSCells. The gNB may then activate, deactivate, or switch the PUCCH sSCell by sending a MAC CE. The UE is configured to use the PUCCH sSCell or the RRC configured PUUCH cell either semi-statically or dynamically.

### TECHNICAL FIELD

This application relates generally to UCI feedback in carrier aggregation deployments and, more particularly, to changing a physical uplink control channel (PUCCH) switching secondary cell (sSCell).

### BACKGROUND INFORMATION

Wireless mobile communication technology uses various standards and protocols to transmit data between a base station and a wireless mobile device. Wireless communication system standards and protocols may include the 3rd Generation Partnership Project (3GPP) long term evolution (LTE) (e.g., 4G) or new radio (NR) (e.g., 5G); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi®.

The latest 5G cellular networking standards support new use cases such as enhanced mobile broadband (eMBB), ultra-reliable low latency communications (URLLC), massive machine type communications (mMTC), cellular vehicle to anything (CV2X) communications and several others that will benefit the industrial revolution into the next decade. Different industry verticals will leverage 5G-enabled connectivity and its benefits in different ways. Mobile network operators will seek to deliver unique service-level agreements (SLAs) to their customers based on specific use cases and their end-to-end emerging cloud native network infrastructure deployments while supporting interworking with other legacy and emerging access technologies.

The following standards provides additional details on 3GPP specifications: 3GPP TS 38.321: “NR; Medium Access Control (MAC) protocol specification.” 3GPP TS 38.211: “NR; Physical channels and modulation.” 3GPP TS 38.212: “NR; Multiplexing and channel coding.” 3GPP TS 38.213: “NR; Physical layer procedures for control.” 3GPP TS 38.214: “NR; Physical layer procedures for data.” 3GPP TS 38.331: “NR; Radio Resource Control (RRC); Protocol specification.” 3GPP TS 38.306: “NR; User Equipment (UE) radio access capabilities.” 3GPP TS 38.300: “NR; NR and NG-RAN Overall description; Stage-2.”

### SUMMARY OF THE DISCLOSURE

Disclosed are techniques for establishing a list of PUCCH sSCells for PUCCH SCell switching. Dynamic activation, switching, and deactivation of PUCCH cells results in effective utilization of the overall RAN resources during complex mobility scenarios. These algorithms may be implemented as licensable software features provide distinct advantages to the overall MAC layer scheduling and performance in multiple RAN deployment configurations. Radisys RAN software feature capabilities can be activated/switched and deactivated via policy-based methods in an automated manner based on RF dynamics and uplink channel reporting conditions from the digital end points (UE). Significant CapEx and OpEx savings for service providers result from deploying unique and innovative software solutions within RAN to optimize coverage, capacity and cost of resource utilization.

Additional aspects and advantages will be apparent from the following detailed description of embodiments, which proceeds with reference to the accompanying drawings.

### BRIEF DESCRIPTION OF THE DRAWING FIGURES

To easily identify the discussion of any particular element or act, the most significant digit or digits in a reference number refer to the figure number in which that element is first introduced.

FIG. 1 is a block diagram of a HARQ process flow in accordance with one embodiment.

FIG. 2 is a block diagram showing a transport block, code block, and code block group in accordance with one embodiment.

FIG. 3 is an abstract syntax notation (ASN) description of an information element (IE) for configuring a code block group in accordance with one embodiment.

FIG. 4 is a block diagram showing carrier aggregation in accordance with one embodiment.

FIG. 5 is a block diagram showing dual connectivity in accordance with one embodiment.

FIG. 6 is an ASN description of IEs for PUCCH cell switching in accordance with one embodiment.

FIG. 7 is an ASN description of IEs for PUCCH SCell switching among a list in accordance with one embodiment.

FIG. 8 a flow diagram for configuration of PUCCH SCell switching among a list in accordance with one embodiment.

FIG. 9 are ASN definitions of IEs for configuring the PUCCH SCell switching accordance with one embodiment.

FIG. 10 is a block diagram showing the PUCCH SCell switching in accordance with one embodiment.

FIG. 11 a pucch-sSCellListToAddModList-r17 configuration for the PCell, SCell1, and SCellN of FIG. 10.

FIG. 12 is a block diagram showing the PUCCH SCell switching in accordance with one embodiment.

FIG. 13 is a block diagram showing the PUCCH SCell switching in accordance with one embodiment.

FIG. 14 is a block diagram showing the PUCCH SCell switching in accordance with one embodiment.

FIG. 15 is a block diagram showing the PUCCH SCell switching in accordance with one embodiment.

FIG. 16 is a block diagram showing the PUCCH SCell switching in accordance with one embodiment.

FIG. 17A and FIG. 17B are a pucch-sSCellListToAddModList-r17 configuration for the primary and secondary PUCCH groups of FIG. 15 and FIG. 16.

FIG. 18A and FIG. 18B are, respectively, upper and lower portions of a flow diagram for dynamic PUCCH SCell switching in accordance with one embodiment.

FIG. 19 is a table showing MAC CE trigger information in accordance with one embodiment.

FIG. 20 is a table showing MAC CE trigger information in accordance with one embodiment.

FIG. 21 is a table showing MAC CE trigger information in accordance with one embodiment.

FIG. 22 is a table showing MAC CE trigger information in accordance with one embodiment.

FIG. 23 is a table showing MAC CE trigger information in accordance with one embodiment.

FIG. 24 is a flow chart of a process in accordance with one embodiment.

FIG. 25 is a flow chart of a process in accordance with one embodiment.

FIG. 26 is a block diagram of computing components for performing the disclosed procedures in accordance with one embodiment.

### DETAILED DESCRIPTION OF EMBODIMENTS

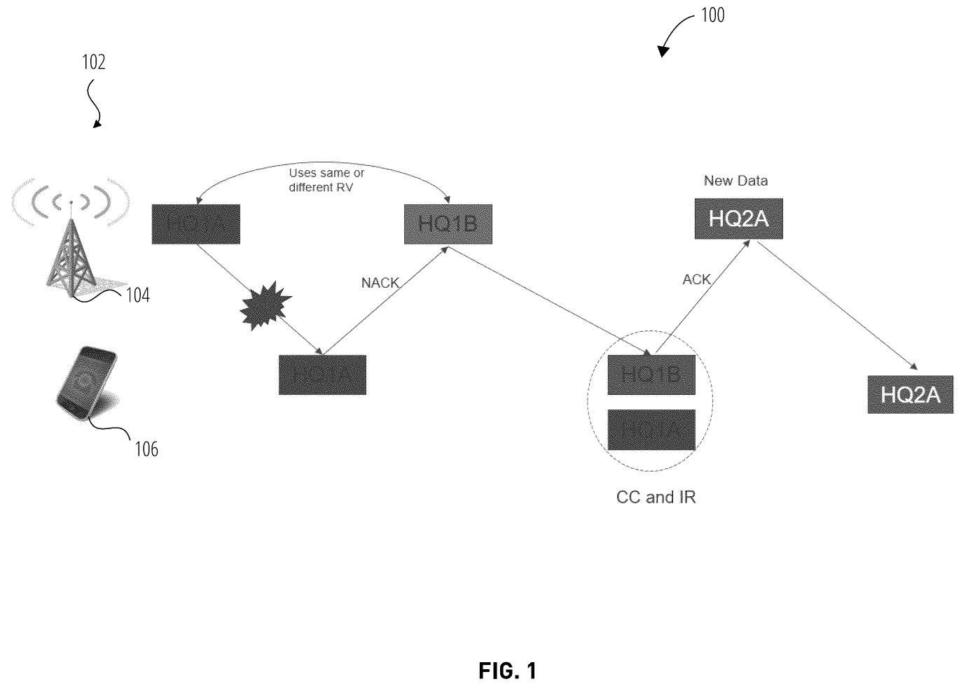

Hybrid automatic repeat request (HARQ) feedback is a backward error correction mechanism for facilitating reliable transmission over NR. For example, FIG. 1 shows a HARQ process 100 in a cellular communications system 102 that includes a gNB 104 and a UE 106. For downlink (DL) transfers, UE 106 sends HARQ ACK/NACK towards gNB 104. For uplink (UL) transfers, gNB 104 sends HARQ ACK/NACK toward UE 106. If a NACK is received, then retransmission will be triggered.

HARQ uses stop and wait mechanism (SAW), i.e., HARQ entity will wait until feedback received from receiver entity before transmitting newer packets. In order to avoid drawbacks due to the SAW mechanism, multiple parallel HARQ entities are defined. While one HARQ entity waits for feedback, the other entity can process newer packets simultaneously, improving latency and processing capabilities. In NR, there can be maximum 32 HARQ processes configured for each serving cell in both DL and UL.

HARQ processes are asynchronous and adaptive in both DL and UL, i.e., during retransmission the resource allocation and allocated modulation coding scheme (MCS) can be changed. For HARQ retransmission, there are two defined mechanisms: 1. Incremental redundancy, and 2. chase combining.

Incremental redundancy uses a different puncturing pattern than the earlier transmission and transmits data. There are four different redundancy versions, i.e., RV0, RV1, RV2, and RV3 currently defined. For transmission, systematic bits get higher priority than parity bits whereas for subsequent retransmission parity bits may have higher priority. For chase combining, similar puncturing patterns are applied to both systematic bits and parity bits for each retransmission and receiver tries to soft combine the retransmitted packet with the original packet received. Performance of incremental redundancy becomes better than that of chase combining when coding rates are high.

In 5G NR, transport block (TB) sizes can be very high due to larger bandwidth. As the TB size is high, if due to any reason a receiver is unable to decode the received TB, then retransmission would be retriggered with the entire TB again. Chances of bit error over air interfaces increases as the TB size is greater. In order to avoid this drawback, 3GPP standards define a mechanism in which the TB will be segmented to a code block (CB), then the CB would be grouped together into code block group (CBG), and feedback would be sent per CBG.

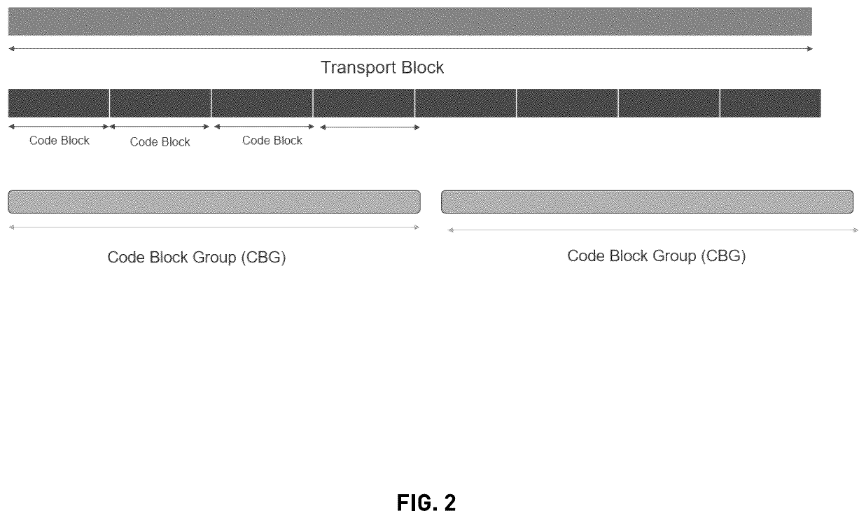

In the current specifications, a cell can be configured as either per TB based HARQ feedback or per CBG based HARQ feedback. Accordingly, FIG. 2 shows that HARQ feedback may be sent by receiving entity based on per TB or per CBG.

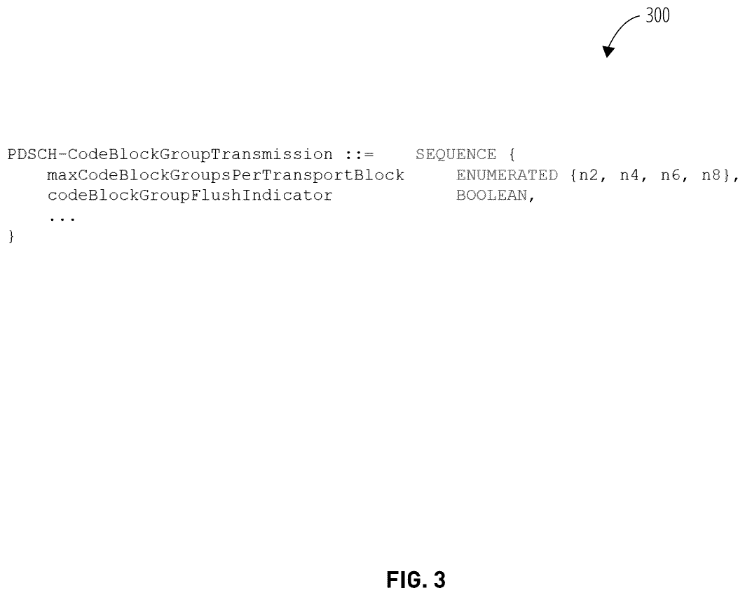

FIG. 3 shows that there can be up to eight CBG configured by a gNB using an IE PDSCH-CodeBlockGroupTransmission 300, which is within PDSCH-ServingCellConfig. In the event an error is observed, then retransmission would be for the CBG. UE support for a CBG transmission depends on the UE capabilities parameter cbg-TransIndication-DL and cbg-FlushIndication-DL within Phy-ParametersCommon.

A first transmission includes all CBG whereas for retransmission includes only those CBG for which NACK was received. CBG transmission information (CBGTI) is included within DCI format 1_1 in order to indicate the CBG details which are being transmitted. CBG flush indicator (CBGFI) within DCI 1_1 is used to indicate if a partially received CBG should be flushed by UE from its buffer.

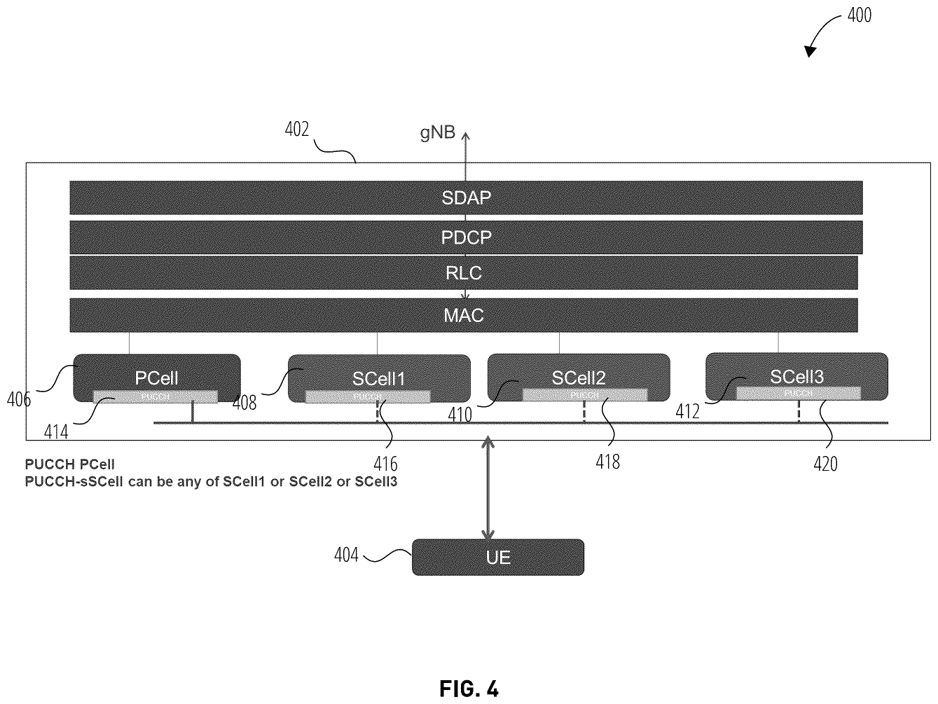

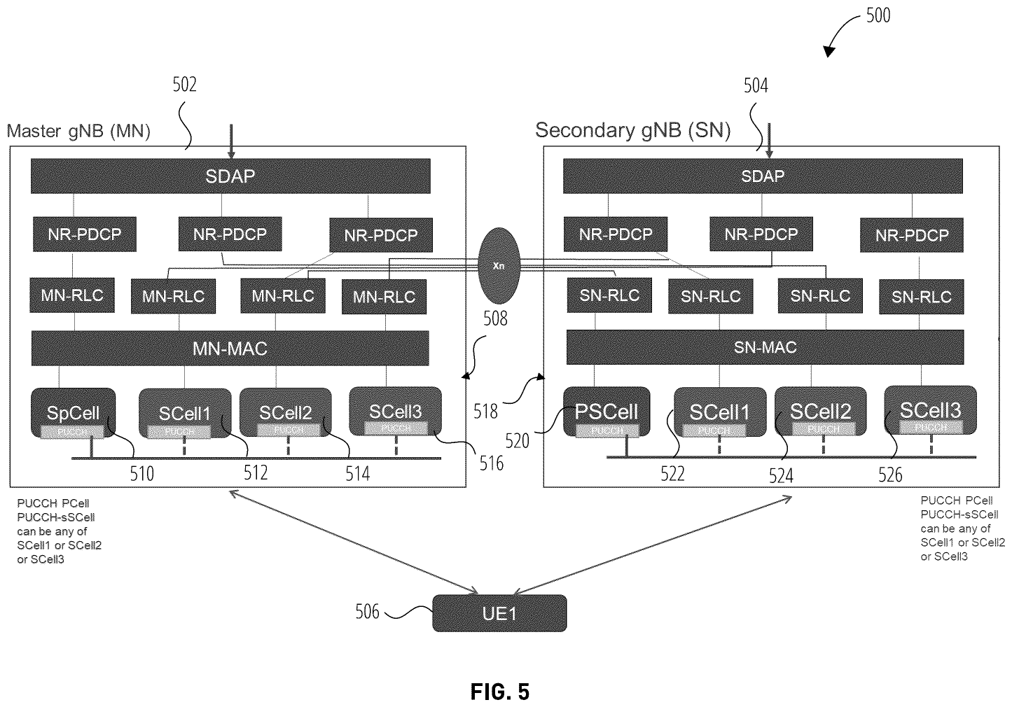

In NR, there are provisions to aggregate carriers across different frequency range, such as for example, combining multiple carriers from FR1 and multiple carriers from FR2. Each component carrier (CC) within a carrier aggregation (CA) deployment may have just a DL or both DL and UL. FIG. 4 and FIG. 5 show examples of carrier aggregation, respectively, without and with dual connectivity (NR-DC). These CA examples are used to explain the concept of a PUCCH switching SCell (PUCCH sSCell) that can be used for PUCCH transmission in addition to the PCell/PSCell/SpCell/PUCCH SCell for the PUCCH transmission (UCI feedback).

FIG. 4 shows a cellular communications system 400 including a gNB 402 and a UE 404. In this example, cellular communications system 400 is configured for CA. In the example of FIG. 4, each CC is configured with PUCCH uplink, such that all CCs have PUCCH resources allocated separately for HARQ feedback. For instance, cellular communications system 400 includes a PCell 406, first SCell 408, second SCell 410, and third SCell 412, and each of which includes a PUCCH for receiving UCI feedback. Specifically, PCell 406 includes a PUCCH 414, first SCell 408 includes a PUCCH 416, second SCell 410 includes a PUCCH 418, and third SCell 412 includes a PUCCH 420.

For PCell 406, first SCell 408 may be a first PUCCH sSCell, at which point the PUCCH sSCell can be switch from first SCell 408 to second SCell 410 or third SCell 412 based on defined criteria described later. Similarly, for first SCell 408, PCell 406 is a first PUCCH sSCell, at which point the PUCCH sSCell can be switched to second SCell 410 or third SCell 412. For second SCell 410, third SCell 412 may be a first PUCCH sSCell, at which point the PUCCH sSCell can be switched to first SCell 408 or PCell 406. For third SCell 412, second SCell 410 may be a first PUCCH sSCell, at which point the PUCCH sSCell can be switched to first SCell 408 or PCell 406.

FIG. 5 shows a cellular communications system 500 for NR dual connectivity (NR-DC) with a 5GC (not shown). Cellular communications system 500 includes a master gNB 502 and a secondary gNB 504 that communicate with a UE 506.

Master gNB 502 includes a master cell group (MCG) 508. MCG 508 includes the cell in which UE 506 first initiates random access (RACH). In this example, MCG 508 includes an SpCell 510 (special cell) and SCells 512, 514, and 516. SpCell 510 and SCell 512, 514, and 516 are combined under MCG 508 through CA. SpCell 510 acts as the PCell of MCG 508.

Similarly, secondary gNB 504 includes a secondary cell group (SCG) SCG 518. In this example, SCG 518 includes a primary secondary cell (PSCell) 520 and SCells 522, 524, and 526. PSCell 520 can be understood as a cell for which initial access is initiated under SCG 518. PScell 520 and SCell 522, 524, and 526 are combined under SCG 518 through CA. PSCell 520 acts as the PCell of SCG 518.

In situations where a secondary CC does not have an uplink, then UCI feedback is sent using primary cell PUCCH resources or using another secondary cell configured as PUCCH SCell based on the PUCCH resource ID in DCI for PDSCH reception and RRC configuration. For instance, during secondary cell configuration, a gNB allocates a cell for the PUCCH resources to be used for UCI transmission of a secondary cell. The cell allocated for PUCCH transmission for a secondary CC is indicated within IE pucch-cell in PDSCH-ServingCellConfig. The IE pucch-cell indicates the ID of the serving cell (of the same cell group) to use for PUCCH. If the field is absent, then the UE sends the HARQ feedback/UCI feedback on the PUCCH of the SpCell/PCell/PSCell of this cell group, or on the same cell if it is a PUCCH SCell.

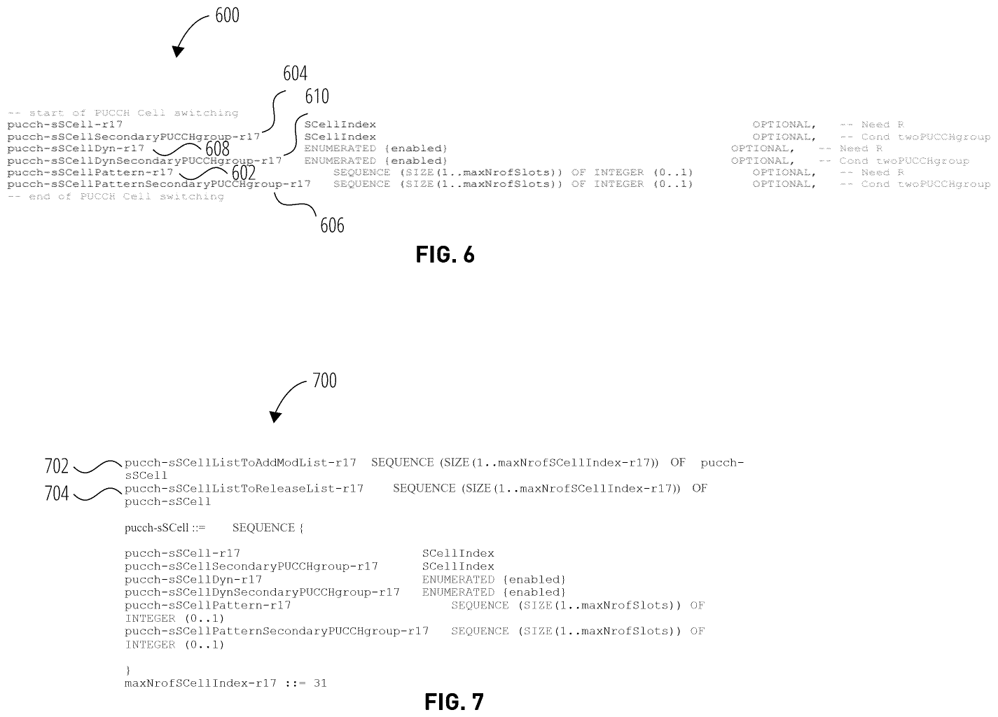

3GPP TS Release 17 specifications introduce the concept of a PUCCH cell switching in which PUCCH UCI feedback may be sent over a PUCCH sSCell in addition to RRC configured pucch-cell. FIG. 6 shows pucch-sSCell IEs 600 introduced to handle PUCCH cell switching in Release 17. Pucch-sSCell IEs 600 are provided in an RRC configuration. The switch between RRC configured PUCCH cell and PUCCH sSCell has been implemented using two techniques.

A first technique uses a semi-static configuration in which a periodic cell switch pattern for PUCCH transmissions is indicated by a pucch-sSCellPattern-r17 602. Each bit of the pattern corresponds to a slot for a reference subcarrier spacing (SCS) configuration provided by tdd-UL-DL-ConfigurationCommon for the PCell/PUCCH SCell with a value of ‘0’ or a value of ‘l’ indicating, respectively, the PCell/PUCCH SCell or the PUCCH sSCell as the cell for PUCCH transmissions during the slot of the reference SCS configuration. IE pucch-sSCellPattern-r17 602 is also applicable for a primary PUCCH group if two PUCCH groups are configured. When a secondary PUCCH group is configured by a pucch-sSCellSecondaryPUCCHgroup-r17 604, then the periodic switch between the PUCCH SCell which are part of secondary PUCCH group and the PUCCH sSCell is based on pattern indicated by a pucch-sSCellPatternSecondaryPUCCHgroup-r17 606. Similarly, for an SCG, the switch is made between the PSCell/PUCCH SCell and the PUCCH sSCell; and for an MCG, the switch is made between the SpCell/PUCCH SCell and the PUCCH sSCell. If the secondary PUCCH group is configured in SCG, then the PUCCH cell switch will be between the PUCCH SCell within SCG which are part of a secondary PUCCH group and the PUCCH sSCell. The UE does not transmit a PUCCH in a slot on a cell if the pattern indicates a different cell for PUCCH transmission during the slot.

A second technique uses a dynamic configuration. If a UE is provided pucch-sSCellDyn-r17 608 or pucch-sSCellDynDCI-1-2-r17 configured within PDSCH-config (not shown), a corresponding DCI format associated with generation of HARQ-ACK information by the UE includes a PUCCH sSCell indicator field with a value of ‘O’ or a value of ‘l’ indicating, respectively, whether a PUCCH transmission with the HARQ-ACK information by the UE is on the PCell/PUCCH SCell or on the PUCCH sSCell. IE pucch-sSCellDyn-r17 608 or pucch-sSCellDynDCI-1-2-r17 configured within PDSCH-config (not shown) are also applicable for a primary PUCCH group if two PUCCH groups are configured. When two PUCCH groups are configured, the UE will use a pucch-sSCellDynSecondaryPUCCHgroup-r17 610 for the secondary PUCCH group. When a secondary PUCCH group is configured, then the PUCCH transmission will be on either the PUCCH SCell which are part of a secondary PUCCH group or the PUCCH sSCell, and similarly for SCG the switch will be between PSCell/PUCCH SCell and PUCCH sSCell; and for an MCG, the switch will be between the SpCell/PUCCH SCell and the PUCCH sSCell. If the secondary PUCCH group is configured in SCG, then the PUCCH cell switch will be between the PUCCH SCell within SCG which are part of a secondary PUCCH group and the PUCCH sSCell. If the secondary PUCCH group is configured for an MCG, then the PUCCH cell switch will be between the PUCCH SCell which are part of a secondary PUCCH group and the PUCCH sSCell.

The following field is included in DCI when the dynamic switch of the PUCCH cell is configured. The PUCCH sSCell indicator is one bit, i.e., it has the value of one if the higher layer parameter pucch-sSCellDyn is configured, and it has the value of zero otherwise. If the UE is configured with two PUCCH groups, then pucch-sSCellDyn is replaced by pucchsSCellDynSecondaryPUCCHgroup for the secondary PUCCH group.

Some drawbacks with the Release-17 approach are, other than PCell, just one other PUCCH sSCell can be selected for sending UCI/HARQ feedback. Thus, a gNB has one option for switching between two cells, which remain fixed and cannot be dynamically modified. PUCCH sSCell switching is not applicable for other configured cells other than the PCell, and the PCell must be configured with time division duplex (TDD). If the PCell is configured with frequency division duplex (FDD), PUCCH sSCell switch is not applicable. This imposes the following constraints as carriers are aggregated and transport networks are configured.

In 5G CA, carriers can be aggregated across FDD and TDD access technologies with dedicated connections in FDD for certain type of applications and services. Cell coverage and capacity could vary based on the CA options across the supported spectrum bands (FR1/FR2/FR1+FR2). If a higher number of CCs are aggregated across multiple spectrum bands, then current standards approach will not provide the required flexibility of dynamically selecting a PUCCH sSCell cell among all configured PUCCH SCells.

Transport network design scenarios may vary depending on operator specific deployments with disaggregated O-RAN network functions using various split models of RU/DU/CU. As a result, the end-to-end latency within the RAN network could vary based on the topology. Hence, semi-static/static means of cell configuration for sending HARQ/UCI feedback is not efficient compared to the disclosed techniques for facilitating that uplink feedback via control channel from the UE to the gNB. Lack of dynamic activation, switching, and deactivation of such uplink control channel exchange limits the RAN performance and inhibits delivery of mission critical and latency sensitive applications.

FIG. 7 shows the structure of PUCCH-sSCells list IEs 700 within PhysicalCellGroupConfig for establishing a list of PUCCH sSCells for PUCCH sSCell switching in an RRC reconfiguration (Layer 3 configuration). A pucch-sSCellListToAddModList-r17 702 provides a sequence of pucch-sSCells to add to the list. Similarly, a pucch-sSCellListToReleaseList-r17 704 provides a sequence of pucch-sSCells to remove from the list. Thus, a gNB configures multiple entries of “PUCCH-sSCell” within PhysicalCellGroupConfig. The number of entries within “PUCCH-sSCell” will depend on number of SCell configure within the cell group having PUCCH SCell. The number of PUCCH sSCell can be less than or equal to max number of configured SCell with PUCCH SCell.

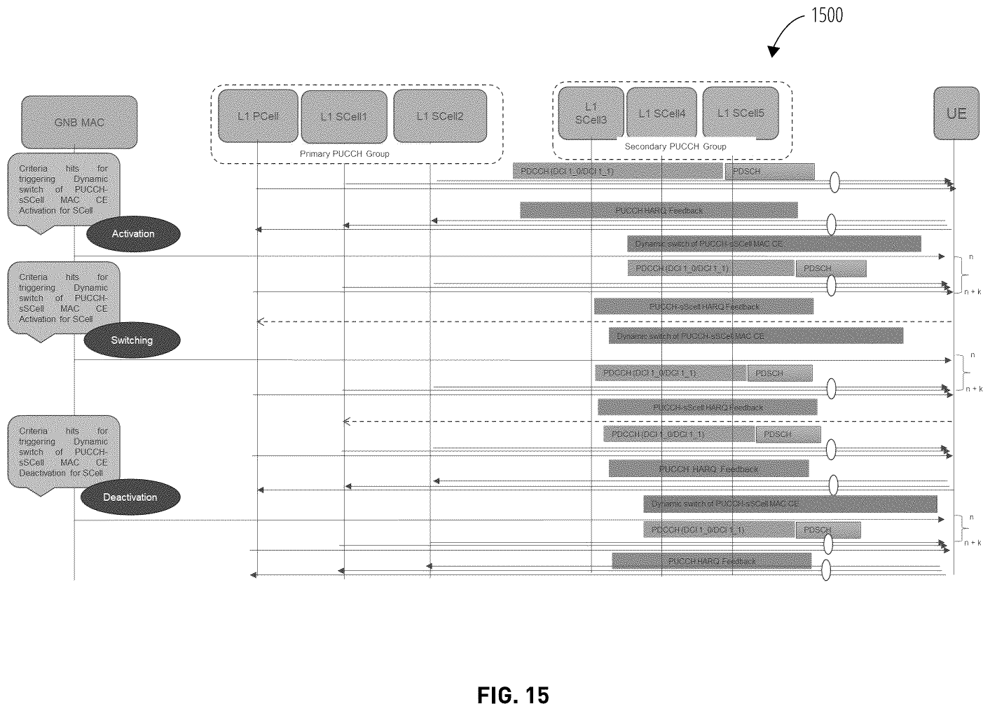

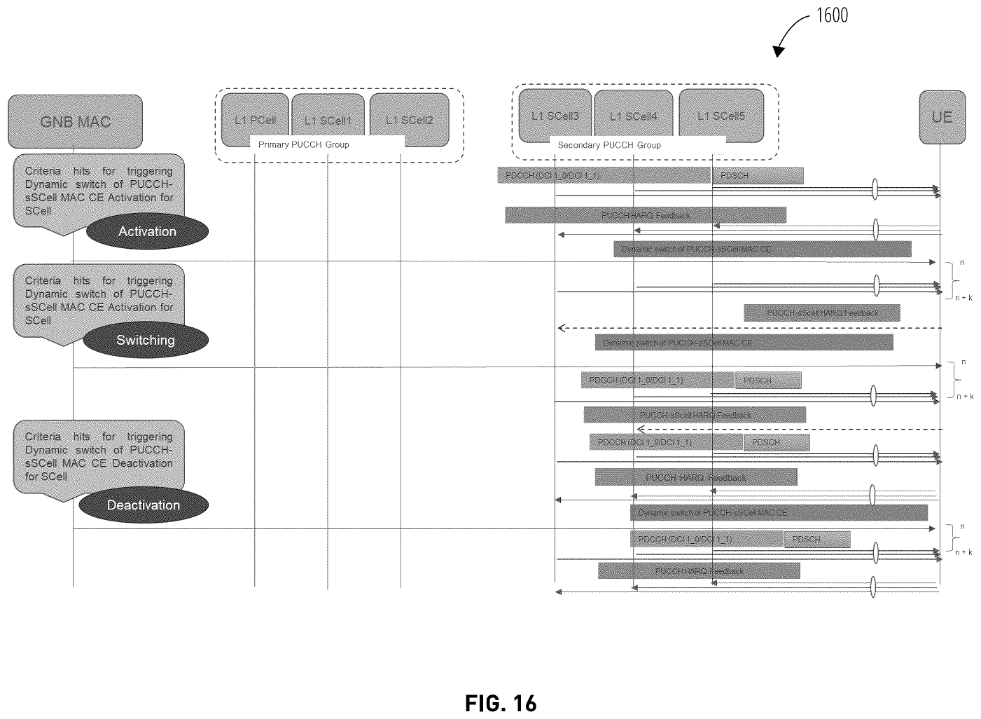

The IE structure defined in FIG. 7 allows configuration of multiple cells for PUCCH sSCell within a group of cells. The same structure can also be used when two PUCCH groups are configured, i.e., a primary PUCCH group and a secondary PUCCH group (see, e.g., FIG. 15 and FIG. 16). For instance, for each PUCCH group, a UE is provided with a PUCCH switch SCell (PUCCH sSCell) that can be used for PUCCH transmission in addition to PCell/SpCell/PSCell/PUCCH SCell. The IE structure defined within PhysicalCellGroupConfig is specific to each cell group. In case multiple cell groups are defined, then for each cell group pucch-sSCell IE structure is defined within PhysicalCellGroupConfig separately, e.g., for NR-DC.

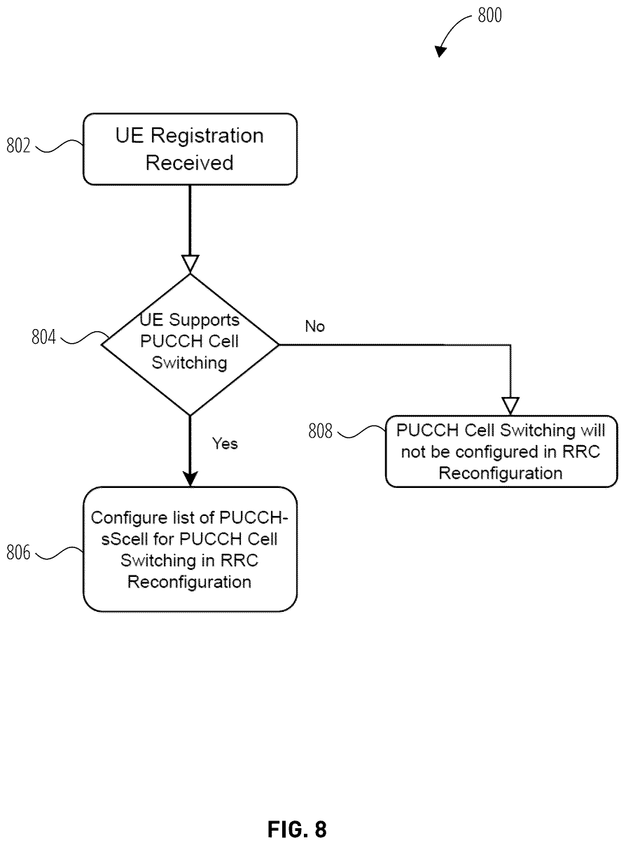

FIG. 8 shows a higher-layer (layer 3) PUCCH sSCell configuration process 800. At a step 802, a gNB receives a registration from a UE. The UE transmits its UE capability information to the gNB during an initial registration procedure. The UE capability information indicates whether the UE supports PUCCH cell switching.

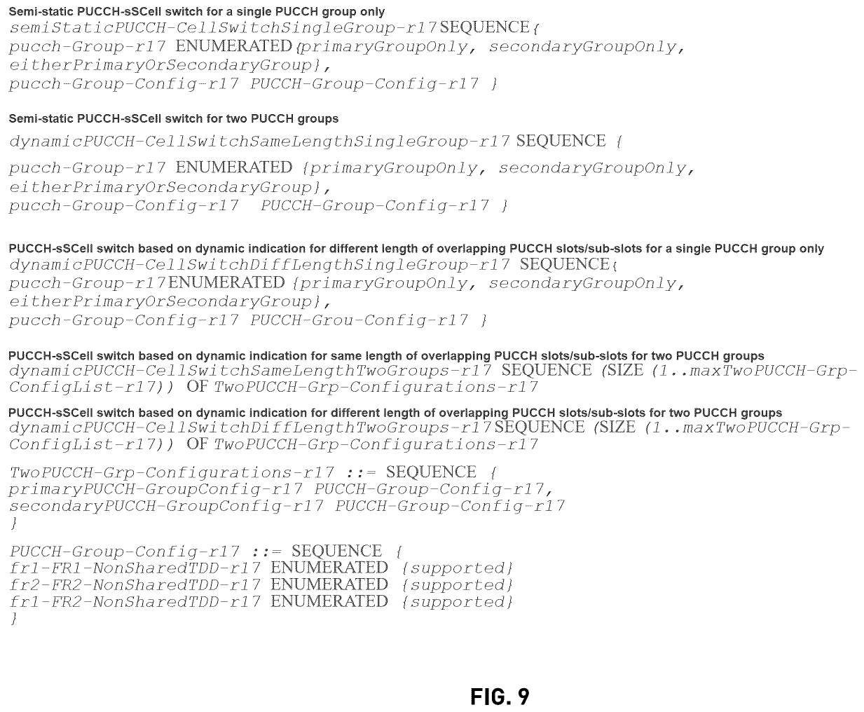

At step 804, the gNB determines whether the UE supports PUCCH cell switching based on the UE capability information. During the initial registration procedure, the gNB will validate UE capability information to validate whether the UE supports PUCCH sSCell switching, since support is optional at the UE. FIG. 9 shows the IEs that the gNB validates in the UE capability information.

After validating UE capabilities, the gNB configures the list of PUCCH sSCells to be used for PUCCH cell switch. At a step 806 the gNB transmits an RRC configuration including a PhysicalCellGroupConfig information element. The PhysicalCellGroupConfig information element includes a sequence of pucch-sSCell information elements to configure multiple cells as PUCCH sSCells, e.g., as shown in FIG. 7.

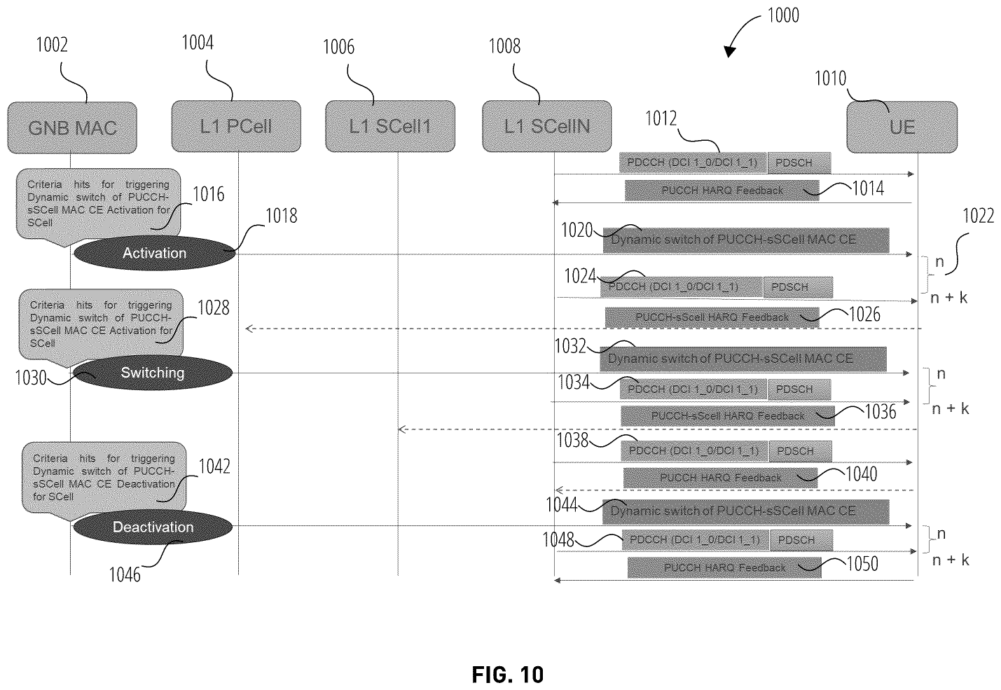

There is flexibility to allocate different PUCCH sSCells with different PUCCH sSCell switch configuration, i.e., semi-static or dynamic. For a semi-static slot configuration, a periodic cell switch pattern for PUCCH transmissions is defined by pucch-sSCellPattern. The PUCCH sSCell switch then happens between PCell/SpCell/PSCell/PUCCH SCell and PUCCH sSCell. For dynamic PUCCH sSCell switching, the switch is done dynamically based on DCI trigger, as shown in the examples of FIG. 10-FIG. 17B.

In case an SCell is deactivated which was configured as PUCCH sSCell, then there are flexibility in using any other configured PUCCH sSCell in active state within same PUCCH group or cell group for transmitting PUCCH other than configured PCell/SpCell/PSCell/PUCCH SCell.

In case the UE does not support PUCCH cell switching, then at a step 808 the gNB provides an RRC reconfiguration without a configuration for PUCCH cell switching. Thus, the gNB does not configure PUCCH sSCell in RRC reconfiguration.

FIG. 9 shows the IEs that the gNB validates in the UE capability information. UE may signal all or some of these IEs as part of UE capability information.

FIG. 10 shows a process 1000 of a gNB MAC 1002 dynamically switching PUCCH sSCells among an L1 PCell 1004, an L1 SCell₁ 1006, and an L1 SCell_{N} 1008 that receive UCI feedback from a UE 1010.

Initially, UE 1010 receives PDCCH and PDSCH 1012 from L1 SCell_{N} 1008. In response, UE 1010 provides PUCCH HARQ feedback 1014 in that same cell as L1 SCell_{N} 1008 configured as the PUCCH sSCell.

Next, gNB MAC 1002 determines whether switch criteria 1016 occurs for triggering a dynamic switch of PUCCH sSCell MAC CE activation 1018. The term activation is used to refer to the dynamic switch of PUCCH sSCell MAC CE that is triggered for first time to active a PUCCH sSCell. The change to an earlier activated PUCCH sSCell is referred to as a switch. In case of a switch, the gNB would first trigger dynamic switch of PUCCH sSCell MAC CE to deactivate the earlier activated PUCCH sSCell and then trigger dynamic switch of PUCCH sSCell MAC CE again to activate new PUCCH sSCell. PUCCH sSCell activation can be triggered for each cell individually, where activation/switching/deactivation is triggered for an individual cell (e.g., L1 SCell_{N} 1008) in FIG. 10.

Dynamic switch of PUCCH sSCell MAC CE provides flexibility of selecting the most appropriate PUCCH sSCell based on different factors. For instance, the triggering is based on one or more of following criteria, explained below: pathloss, PUCCH resource location in the resource grid, block error rate (BLER), load on cell, cross fronthaul deployment type, selected antenna port, configured PUCCH sSCell switch pattern, and type of spectrum used.

Pathloss: A pathloss offset may be defined internally within a gNB. If pathloss delta between two different PUCCH sSCells within same cell group is beyond the defined offset value, then dynamic switch of PUCCH sSCell MAC CE will be triggered by gNB MAC 1002 to inform UE 1010 to use cells having better pathloss for transmission of UCI. If PCell/PSCell/SpCell/PUCCH SCell pathloss becomes better than that of the PUCCH sSCell, then all UCI on PUCCH will be sent on PCell/PSCell/SpCell/PUCCH SCell. If the PUCCH sSCell pathloss becomes better than that of the current PCell/PSCell/SpCell/PUCCH SCell, then all UCI will be sent on PUCCH of sSCell. In order to avoid too frequent triggering of dynamic switch of PUCCH sSCell MAC CE, a hysteresis may be defined in range of min value of −10 to +10 dB around the defined pathloss offset. In case the pathloss does not meet criteria of the pathloss offset, then deactivation of the dynamic switch of PUCCH sSCell MAC CE may be triggered. Pathloss plays a role in case of carrier aggregation across different frequency ranges. Based on pathloss multiple configured PUCCH sSCell over RRC can be listed from better to worse, and the gNB may chose best PUCCH sSCell in dynamic switch of PUCCH sSCell MAC CE.

PUCCH resource location in Resource Grid: PUCCH resource location may be considered while triggering activation/deactivation of dynamic switch of PUCCH sSCell MAC CE. If PUCCH resources falls towards bandwidth edge for any of the cell and for another cell PUCCH resource does not fall on bandwidth edge, then dynamic switch of PUCCH sSCell MAC CE could be triggered for cell having PUCCH resources at bandwidth edge. If PUCCH feedback sent on resources that are present at bandwidth edge, then PUCCH resources will experience higher interference resulting in higher percentage bad reception of PUCCH resources. By switching to PUCCH sSCell having resources relatively farther from cell edge will mitigate the issue seen due to transmission of PUCCH resources at bandwidth edge.

Block Error Rate (BLER): BLER may be considered for triggering activation and deactivation of dynamic switch of PUCCH sSCell MAC CE. A BLER offset may be defined during configuration. Dynamic switch of PUCCH sSCell MAC CE activation may be triggered to configure different PUCCH sSCell if BLER offset becomes worse than other configured PUCCH cell, i.e., PUCCH sSCell or PCell/PSCell/SpCell/PUCCH SCell towards the UE. Similarly, deactivation of dynamic switch of PUCCH sSCell MAC CE will be triggered if BLER threshold is exceeded on configured PUCCH sSCell. If BLER threshold is exceeded in current PUCCH sSCell after receiving activation of dynamic switch of PUCCH sSCell MAC CE, then PUCCH sSCell may be deactivated and a new PUCCH sSCell activation MAC CE may be triggered indicating a different PUCCH sSCell.

Load on cell: Load on cell may be considered while determining PUCCH sSCell. In case if any of the cells are overloaded, then dynamic switch of PUCCH sSCell MAC CE could be triggered to switch PUCCH sSCell to a cell having relatively lower load. This helps in optimizing the overall system performance for HARQ reception. This scenario is applicable when multi-CC CA is configured, and UE is scheduled with peak data rate.

Cross Fronthaul deployment type: Fronthaul between DU and RU can be deployed with multiple deployment type such as fiber, PON, DOCSIS, etc., which provide variable latency. If one cell has a fiber fronthaul and another cell has DOCSIS, then fronthaul latency will be better with fiber fronthaul. So, transmitting PUCCH HARQ/UCI feedback for both cells over fiber fronthaul will improve overall latency with better performance gain. Dynamic switch of PUCCH sSCell MAC CE could be triggered to switch PUCCH sSCell to a cell where fronthaul is configured with fiber.

Selected Antenna port: UE may have more no of antenna ports than the number configured rank in uplink. So, UE must choose subset of antenna for transmission in uplink. Some antenna port provides better performance than others due to bad reception in some antenna port e.g., a user might have put finger where the antenna is located in the UE. For different frequency UE may be configured to use different antenna port. For example, separate antenna port will be used by UE when transmitting on FR1 frequency than FR2 frequency. In case if one cell using one antenna port providing better performance than the other cell using different antenna port in uplink then Dynamic switch of PUCCH sSCell MAC CE could be triggered to switch PUCCH sSCell to the cell with better performance in uplink due to selected antenna port.

Configured PUCCH sSCell Switch Pattern: Different PUCCH sSCell can be configured with different PUCCH switching pattern between PCell/PSCell/SpCell/PUCCH SCell and PUCCH sSCell. PUCCH cell switching can be triggered periodically or dynamically based on scheduled DCI. If QOS requirement is going to be fixed over a period and does not require changes then in Dynamic switch of PUCCH sSCell MAC CE will contain PUCCH sSCell with periodic PUCCH cell switch resources otherwise if QOS requirement changes too frequently then in dynamic switch of PUCCH sSCell MAC CE will contain PUCCH sSCell with dynamic PUCCH cell switch resources in DCI Format 1_1 and 1_2.

Type of spectrum used: Each cell can be deployed with either Frequency Division Duplex (FDD) or Time Division Duplex (TDD). FDD deployment provides dedicated uplink for transmission of PUCCH whereas for TDD, transmission of PUCCH can be at a specific time based on configured slot format. A dynamic switch of PUCCH sSCell MAC CE could be triggered to configure PUCCH sSCell where PUCCH sSCell with FDD deployment takes precedence over TDD deployment especially for a URLLC application where latency plays a major role.

UE 1010 was sending UCI information for L1 SCell_{N} 1008 over same cell, as L1 SCell_{N} 1008 is a PUCCH SCell. Switch criteria 1016 the arises for triggering the dynamic switch of PUCCH sSCell MAC CE activation for L1 SCell_{N} 1008. GNB MAC 1002 triggers the dynamic switch of PUCCH sSCell MAC CE command to activate L1 PCell 1004 as PUCCH sSCell for individual cell L1 SCell_{N} 1008. In the example of FIG. 10, once one or more of the aforementioned trigger criteria are met, gNB MAC 1002 triggers the dynamic switch of PUCCH sSCell MAC CE message 1020 towards UE 1010.

Now, L1 SCell_{N} 1008 UCI is sent over L1 PCell 1004, i.e., PUCCH sSCell or on L1 SCell_{N} 1008 as indicated in DCI for dynamic configuration or in a pucch-sSCellPattern in RRC message for semi-static configuration. For any SCell, the PUCCH sSCell can be another configured PUCCH SCell or PCell/PSCell/SpCell and for PCell it may be a PUCCH SCell. To activate the dynamic switch of a PUCCH sSCell, gNB MAC 1002 sends a MAC CE message 1020 to UE 1010 with information identifying the PUCCH sSCell. An example of MAC CE message 1020 is shown and described later with reference to FIG. 23. A MAC CE command for dynamic switch of PUCCH sSCell is applicable for both PCell and PUCCH SCell and can be triggered separately or can have a common PUCCH sSCell across both PCell and PUCCH SCell. The dynamic switch of PUCCH sSCell MAC CE will select one of the cells among all configured PUCCH sSCell in RRC for HARQ feedback/UCI indication.

Once dynamic switch of PUCCH sSCell MAC CE message 1020 is received, then UE 1010 will use configured PUCCH sSCell in addition to configured PUCCH SCell for transmission of all Uplink Control Information (UCI), i.e., Channel State Information (CSI) Report, Scheduling Request (SR) and Hybrid Automated Repeated Request (HARQ) over PUCCH when periodic cell switching is configured between PUCCH SCell and PUCCH sSCell or only HARQ feedback over PUCCH when dynamic cell switching is configured between PUCCH SCell and PUCCH sSCell.

When UE 1010 receives MAC CE message 1020 for dynamic switch of PUCCH sSCell at slot n, then it will apply it no earlier than a delay 1022 of n+k where k is given by the following Equation 1.

$$m + 3 {N}_{slot}^{subframe , μ} + 1 \qquad Equation 1$$

In Equation 1, Nₛₗₒₜ^{subframe,μ} is a number of slots per subframe for the SCS configuration u. Slot n+m is a slot indicated for PUCCH transmission with HARQ-ACK information for the PDSCH reception. For DCI format 1_0, the PDSCH-to-HARQ_feedback timing indicator field values map to {1, 2, 3, 4, 5, 6, 7, 8} for SCS configuration of PUCCH transmission u≤3, to {7, 8, 12, 16, 20, 24, 28, 32} for u=5, and to {13, 16, 24, 32, 40, 48, 56, 64} for u=6. For a unicast DCI format, other than DCI format 1_0 the PDSCH-to-HARQ provided by higher layer parameter dl-DataToUL-ACK, dl-DataToUL-ACK-r16, or dl-DataToUL-ACK-DCI-1-2, or dl-DataToUL-ACK-r17, or dl-DataToUL-ACK-DCI-1-2-r17.

For example, if UE 1010 is last scheduled using DCI 1_1 with dl-DataToUL-ACK value set to 7 with u=1 then the value Equation 1 is 14 slots (7+3×2+1). Thus, if UE 1010 receives a dynamic switch of PUCCH sSCell MAC CE for either activation or deactivation in a current slot, then MAC CE command will be applied after 14 slots from the current slot. The reason for allowing delay 1022 in activation or deactivation for dynamic switch of PUCCH sSCell MAC CE is that UE 1010 might have been scheduled for prior transmission of PUCCH on previously configured PUCCH sSCell or PUCCH cell. For newer transmissions, after transmission of dynamic switch of PUCCH sSCell MAC CE, if PUCCH cell switch is triggered then the UE will be scheduled with newly indicated PUCCH sSCell for transmission of UCI feedback. Skilled persons will appreciate that the values will be different for different subcarrier spacing as number of slots per subframe changes for each subcarrier spacing. Similarly, other factors that affect the timing of dynamic switch of PUCCH sSCell MAC CE will be timing difference between PUCCH HARQ feedback transmission for received PDSCH. Both these factors are taken into consideration as there may be pending transmission of HARQ feedback on currently configured PUCCH sSCell for received PDSCH and UE will only switch to new PUCCH sSCell after all pending HARQ feedback transmitted.

When UE 1010 receives PDCCH and PDSCH 1024, it transmits PUCCH-sSCell HARQ feedback 1026. Based on MAC CE message 1020, PUCCH-sSCell HARQ feedback 1026 is sent to L1 PCell 1004 instead of L1 SCell_{N} 1008, thereby using the PUCCH sSCell instead of the RRC configured PUCCH cell.

In general, once PUCCH sSCell is activated using dynamic switch of PUCCH sSCell MAC CE, UE 1010 will use PUCCH sSCell in addition to configured PUCCH SCell for transmission of HARQ feedback only over PUCCH when pucch-sSCellDyn or pucch-sSCellDynDCI-1-2 or pucchsSCellDynSecondaryPUCCHgroup is configured.

In DCI format 1_1 and 1_2 there is no change, as it will set PUCCH sSCell indicator to 1 after receiving activation command for dynamic switch of PUCCH sSCell MAC CE when pucch-sSCellDyn or pucch-sSCellDynDCI-1-2 is configured. The PUCCH sSCell indicator is 0 or 1 bit: 1 bit if higher layer parameter pucch-sSCellDyn or pucch-sSCellDynDCI-1-2 is configured; and 0 bit otherwise. If the UE is configured with a PUCCH SCell, pucch-sSCellDyn is replaced by pucchsSCellDynSecondaryPUCCHgroup for the secondary PUCCH group.

If a UE is provided pucch-sSCellDyn or pucch-sSCellDynDCI-1-2 or pucchsSCellDynSecondaryPUCCHgroup, a corresponding DCI format associated with generation of HARQ-ACK information by the UE can include a PUCCH cell indicator field with a value of ‘0’ or a value of ‘l’ indicating, respectively, whether a PUCCH transmission with the HARQ-ACK information by the UE is on the PCell/PSCell/SpCell/PUCCH SCell or on the PUCCH sSCell.

For PUCCH slot overlapping between PUCCH sSCell and PCell/PSCell/SpCell/PUCCH SCell will follow similar approach as standardized in TS 38.213 section 9.A, i.e., “A slot on the active UL BWP of the PUCCH sSCell does not overlap with more than one slot on the active UL BWP of the PCell/PSCell/SpCell/PUCCH SCell. If a slot for the active UL BWP of the PCell/PSCell/SpCell/PUCCH SCell overlaps with more than one slot on the active BWP of the PUCCH sSCell and the UE would transmit a PUCCH on the PUCCH sSCell, the UE considers the first of the overlapping slots for the PUCCH transmission on the PUCCH sSCell.”

The PUCCH sSCell switch when overlapping of PUCCH sSCell and PCell/PSCell/SpCell/PUCCH SCell slot can be categorized as below PUCCH sSCell switch based on dynamic indication for different length of overlapping PUCCH slots/sub-slots for a single PUCCH group only. PUCCH sSCell switch based on dynamic indication for same length of overlapping PUCCH slots/sub-slots for two PUCCH groups. PUCCH sSCell switch based on dynamic indication for different length of overlapping PUCCH slots/sub-slots for two PUCCH groups. Each of above mentioned PUCCH sSCell and PCell/PSCell/SpCell/PUCCH SCell slot overlapping support is subject to UE reporting support in UE capability Information towards gNB. The handling of overlapping of two PUCCH cell when PUCCH cell switching is configured will be done as defined in TS 38.213.

The UE does not expect the PUCCH sSCell indicator field to indicate the PUCCH sSCell for a PUCCH transmission in a slot that overlaps with a slot on the PCell/PSCell/SpCell/PUCCH SCell where the UE would transmit another PUCCH on PCell/PSCell/SpCell/PUCCH SCell.

The PUCCH sSCell switch is applicable to all UCI types when using the higher layer configured time-domain pattern for periodic PUCCH cell switch but is only applicable to HARQ feedback for the dynamic indication of the cell for PUCCH transmission through a PDCCH scheduling PUCCH through DCI format 1_1 or DCI format 1_2.

For an Ultra Reliable Low Latency Communication (URLLC) case the latency plays a major role for achieving desired Quality of Service (QOS). In TDD system the delay in time domain switch between uplink and downlink brings constrains in designing an optimal URLLC performances. Configuring a dynamically PUCCH sSCell having dedicated uplink, i.e., a FDD carrier may help in overcoming the issue arose.

UE will use the following values from the indicated PUCCH sSCell for PUCCH transmit power determination for power control after receiving activation command for the dynamic switch of PUCCH sSCell MAC CE: (1) a p0-PUCCH-Value from pucch-PowerControl in PUCCH-Config for the PUCCH sSCell for the determination P_{0,PUCCH,b,f,c}(qᵥ); (2) a pucch-PathlossReferenceRS-Id from pucch-PowerControl in PUCCH-Config for the PUCCH sSCell for the determination of PL_{b,f,c}(q_{d}); and a PUCCH power control adjustment state g_{b,c,f}(i,l) for active UL BWP b of the UL carrier f of PUCCH sSCell c PUCCH transmission occasion i and closed loop power control adjustment state I where δ_{PUCCH,b,0,c}(i, l) is a TPC command value included in a DCI format associated with generation of HARQ-ACK information for multiplexing in a PUCCH transmission on the PUCCH sSCell as indicated either by a pucch-sSCellPattern or by a PUCCH sSCell indicator field in the DCI format, or provided by DCI format 2_2 with CRC scrambled by TPC-PUCCH-RNTI for the PUCCH sSCell as described in TS 38.213 clause 11.3.

Next, gNB MAC 1002 continues to check switch criteria 1028. L1 SCell1 1006 becomes better candidate to serve PUCCH sSCell than L1 PCell 1004 based on defined criteria. The dynamic switch 1030 of PUCCH sSCell MAC CE is triggered to deactivate L1 PCell 1004 as PUCCH sSCell followed by one more dynamic switch of PUCCH sSCell MAC CE to activate L1 SCell1 1006 as PUCCH sSCell for L1 SCell_{N} 1008. These two messages are represented in FIG. 10 as MAC CE message 1032. Now, L1 SCell_{N} 1008 UCI is sent over L1 SCell1 1006, i.e., PUCCH sSCell or on L1 SCell_{N} 1008 as indicated in DCI for dynamic configuration or pucch-sSCellPattern in RRC message for semi-static configuration.

UE 1010 then receives a PDCCH and PDSCH 1034. After a delay, it provides PUCCH-sSCell HARQ feedback 1036, which is now sent to L1 SCell1 1006 (as previously identified in the MAC CE message 1032).

For the next PDCCH and PDSCH 1038, however, UE 1010 once again sends PUCCH HARQ feedback 1040 to the default PUCCH cell L1 SCell_{N} 1008 configured through RRC. Also, dynamic switch of PUCCH sSCell MAC CE will not be applicable when semi-persistence scheduling (SPS) or configured grant (CG) scheduling is enabled.

Finally, when gNB MAC 1002 checks switch criteria 1042 to return to the default PUCCH cell, it provides a MAC CE message 1044 to UE 1010 for a deactivation 1046 of the PUCCH sSCell. In general, when a deactivation command is received for PUCCH sSCell, then UE 1010 will use RRC configured cell for PUCCH transmission. In case the current cell is an SCell, and it is not configured as PUCCH SCell, then PCell or PSCell or SpCell will be used for transmission of PUCCH as configured by RRC. The NG-RAN ensures that PUCCH-sSCells mapped to PUCCH SCell are deactivated before the PUCCH SCell is changed or removed.

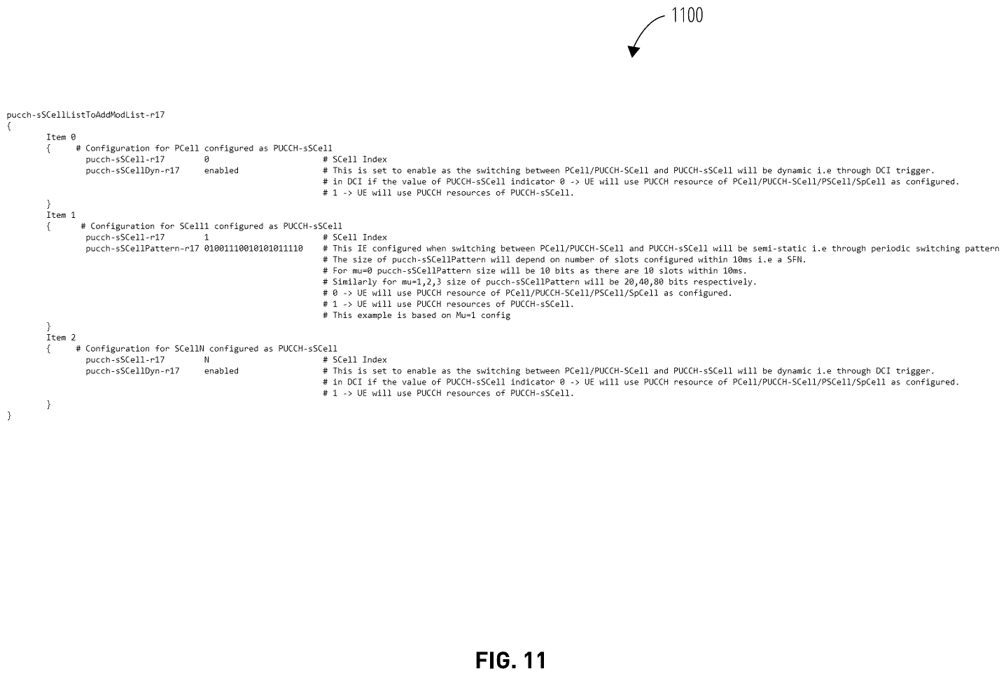

FIG. 11 shows a pucch-sSCellListToAddModList-r17 configuration 1100 for the PCell, SCell1, and SCell_{N} of FIG. 10. In this example, the UE is configured so that the PCell and SCell_{N} are configured with dynamic PUCCH sSCells switching patterns. The UE is also configured so that the SCell1 is configured with semi-static PUCCH sSCell switching pattern.

For PCell and SCell_{N}, pucch-sSCellDyn-r17 is configured indicating a DCI based switching supported between RRC configured PUCCH cell and PUCCH sSCell. In DCI, if the value of PUCCH sSCell indicator set to zero, then the UE will use the PUCCH resource of RRC configured cell for transmission of HARQ feedback, i.e., SCell_{N} as per FIG. 10. If PUCCH sSCell indicator is set to one, then the UE will use PUCCH resources of PUCCH sSCell to transmit HARQ feedback, i.e., PCell as per FIG. 10.

For SCell1 pucch-sSCellPattern-r17 is configured indicating a periodic switching pattern between RRC configured PUCCH cell and PUCCH sSCell. If a bit value in pucch-sSCellPattern-r17 is set to zero, it indicates the UE will use RRC configured PUCCH resources for transmission of UCI feedback in the mapped slot, i.e., SCell_{N} as per FIG. 10. For bit value set to one in pucch-sSCellPattern-r17, the UE will use PUCCH sSCell, PUCCH resources for transmission of UCI feedback in the mapped slot, i.e., SCell1 as per FIG. 10.

The size of pucch-sSCellPattern will depend on number of slots configured within 10 ms, i.e., a SFN. For mu=0 pucch-sSCellPattern size will be 10 bits as there are 10 slots within. Similarly for mu=1, 2, 3, the size of pucch-sSCellPattern will be 20, 40, 80 bits, respectively. In FIG. 11 the pucch-sSCellPattern is defined according to mu=1 subcarrier spacing.

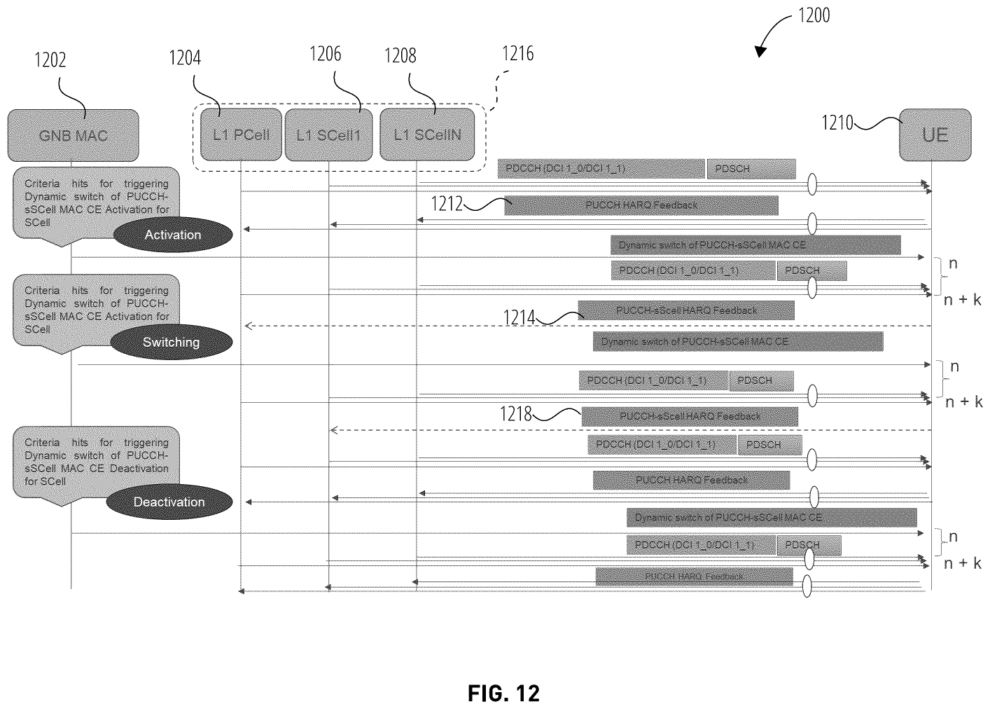

PUCCH sSCell activation can be triggered per cell group, i.e., a single PUCCH sScell is available for all the cells present in the cell group where activation/switching/deactivation is triggered per cell group. FIG. 12, for instance, shows a process 1200 of a gNB MAC 1202 dynamically switching PUCCH sSCells, configured per a cell group, among an L1 PCell 1204, an L1 SCell1 1206, and an L1 SCell_{N} 1208 that receive HARQ feedback from a UE 1210.

In this example, PUCCH HARQ feedback 1212 is initially provided to for each of the cells in the cell group. In other words, each cell is a PUCCH cell with PUCCH resources available. The UE is sending UCI information for each cell over same cell, i.e., PCell UCI is sent over the PCell, SCell1 UCI is sent over SCell1, and SCell_{N} UCI is sent over SCell_{N} (i.e., both SCell1 and SCell_{N} are PUCCH SCells).

Criteria is then determined for triggering a dynamic switch of PUCCH sSCell MAC CE activation per cell group. The gNB MAC triggers the dynamic switch of PUCCH sSCell MAC CE command to activate PCell as PUCCH sSCell for all the cells configured as part of cell group. Activation, switching, and deactivation are similar to those of process 1000, but in process 1200 a PUCCH-sSCell HARQ feedback 1214 is provided to L1 PCell 1204 for all cells in cell group 1216. Now, SCell_{N} UCI is sent over PCell (i.e., PUCCH sSCell) or over SCell_{N}, as indicated in DCI for dynamic configuration or pucch-sSCellPattern in RRC message for semi-static configuration. Similarly, SCell1 UCI is sent over PCell (i.e., PUCCH sSCell) or on SCell1, as indicated in DCI for dynamic configuration and pucch-sSCellPattern in RRC message for semi-static configuration. As PCell is configured as PUCCH sSCell for the cell group, all UCI feedback for PCell will be sent over PCell only.

Next, SCell1 becomes the better candidate to serve as the PUCCH sSCell (rather than the PCell) based on defined criteria for the cell group. The dynamic switch of PUCCH sSCell MAC CE is triggered to deactivate PCell as PUCCH sSCell, followed by one more dynamic switch of PUCCH sSCell MAC CE to activate SCell1 as PUCCH sSCell for the cell group. After switching, PUCCH-sSCell HARQ feedback 1218 is provided to L1 SCell1 1206. Specifically, SCell_{N} UCI is then sent over SCell1 (i.e., PUCCH sSCell) or on SCell_{N}, as indicated in DCI for dynamic configuration or pucch-sSCellPattern in RRC message for semi-static configuration. Similarly, PCell UCI is sent over SCell1 (i.e., PUCCH sSCell) or on PCell as indicated in DCI for dynamic configuration and pucch-sSCellPattern in RRC message for semi-static configuration. As SCell1 is configured as PUCCH sSCell for the cell group, all UCI feedback for SCell1 will be sent over SCell1 only.

When none of the cell satisfies criteria to serve as PUCCH sSCell for the cell group, the gNB MAC triggers the dynamic switch of PUCCH sSCell MAC CE to deactivate PUCCH sSCell, i.e., SCell1. Now all UCI for each cell will be sent over cell as indicated by RRC, i.e., UCI information for each cell will be sent over same cell.

In some embodiments, the PUCCH sSCell is configured generically across all cells/PUCCH groups. Then, through MAC CE message, a PUCCH sSCell will be allocated/activated to different PUCCH group or cells.

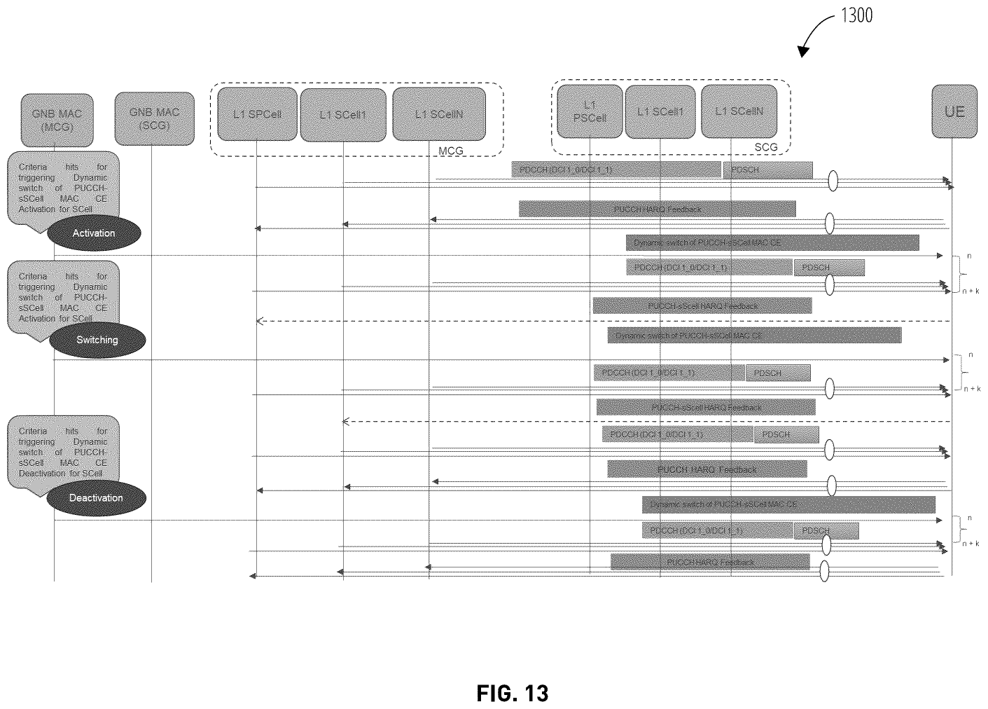

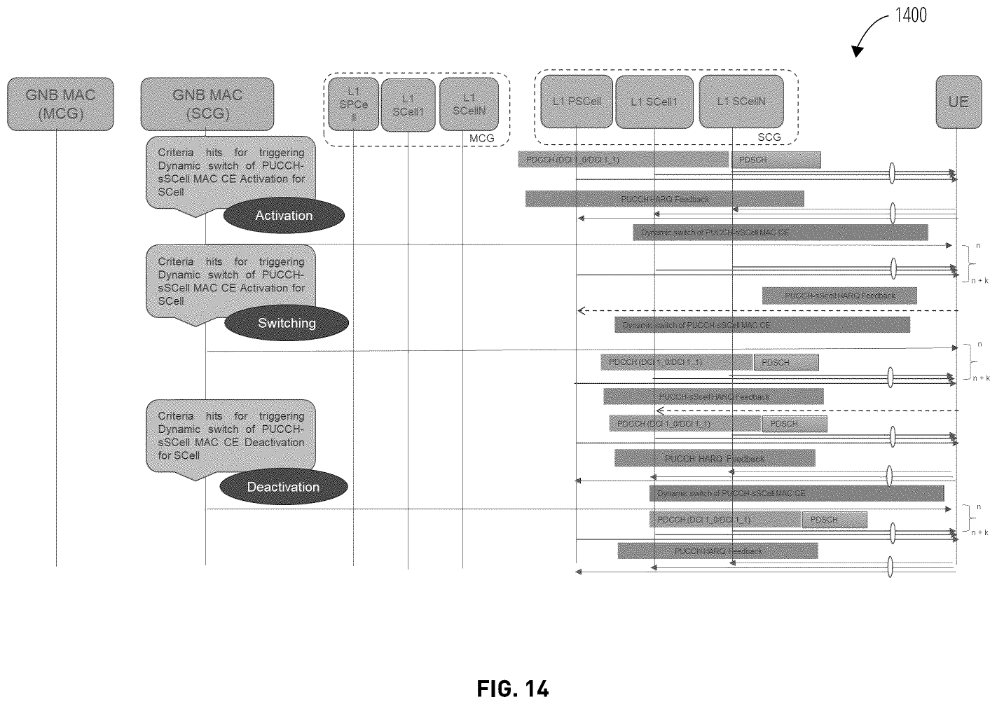

FIG. 13 and FIG. 14 show, respectively, a process 1300 and a process 1400 to dynamically switch PUCCH sSCell for NR-DC MCG (FIG. 13) and SCG (FIG. 14). In other words, in situations with NR-NR dual connectivity, dynamic switch of PUCCH sSCell MAC CE is applicable per MCG (FIG. 13) or SCG (FIG. 14) and can be across all cells configured within MCG and SCG. For MCG, separate dynamic switch of PUCCH MAC CE will be used for PUCCH sSCell switch across configured SPCell and PUCCH SCell. Within a SCG, the dynamic switch of PUCCH sSCell MAC CE can be triggered for configured PSCell and PUCCH SCell. For a SPCell, the PUCCH sSCell can be any configured PUCCH SCell. For a PSCell, the PUCCH sSCell can be any configured PUCCH-SCell.

With reference to FIG. 13, initially this UE sends UCI information for each cell over the same cell, i.e., SPCell UCI is sent over the SPCell, SCell1 UCI is sent over SCell1, and SCellN UCI is sent over SCellN (both SCell1 and SCellN are PUCCH SCells). Criteria then hits for triggering the dynamic switch of PUCCH sSCell MAC CE activation for MCG. The gNB MAC triggers the dynamic switch of PUCCH sSCell MAC CE command to activate SPCell as PUCCH sSCell for all the cells configured as part of MCG.

Then, SCellN UCI is sent over SPCell, (i.e., PUCCH sSCell) or on SCellN, as indicated in DCI for dynamic configuration or pucch-sSCellPattern in RRC message for semi-static configuration. Similarly, SCell1 UCI is sent over SPCell, (i.e., PUCCH sSCell) or on SCell1, as indicated in DCI for dynamic configuration or pucch-sSCellPattern in RRC message for semi-static configuration. As SPCell is configured as PUCCH sSCell for the cell group, all UCI feedback for SPCell will be sent over SPCell only.

Next, SCell1 becomes a better candidate to serve as the PUCCH sSCell compared to the SPCell, based on defined criteria for the MCG. The dynamic switch of PUCCH sSCell MAC CE is triggered again to deactivate SPCell as PUCCH sSCell followed by one more dynamic switch of PUCCH sSCell MAC CE to activate SCell1 as PUCCH sSCell for the MCG.

Accordingly, SCellN UCI is sent over SCell1, (i.e., PUCCH sSCell) or on SCellN, as indicated in DCI for dynamic configuration or pucch-sSCellPattern in RRC message for semi-static configuration. Similarly, SPCell UCI is sent over SCell1 (i.e., PUCCH sSCell) or on SPCell, as indicated in DCI for dynamic configuration or pucch-sSCellPattern in RRC message for semi-static configuration. As SCell1 is configured as PUCCH sSCell for the cell group, all UCI feedback for SCell1 will be sent over SCell1 only.

When none of the cell satisfy criteria to serve as PUCCH sSCell for the MCG, the gNB MAC triggers the dynamic switch of PUCCH sSCell MAC CE to deactivate PUCCH sSCell (i.e., SCell1). Thus, all UCI for each cell will be sent over cell as indicated by RRC, i.e., UCI information for each cell will be sent over same cell.

FIG. 14 shows that, initially, UE sends UCI information for each cell over same cell, i.e., PSCell UCI is sent over PSCell, SCell1 UCI is sent over SCell1, and SCellN UCI is sent over SCellN, as both SCell1 and SCellN are PUCCH SCells. Next, criteria hits for triggering the dynamic switch of PUCCH sSCell MAC CE activation for SCG. The gNB MAC triggers the dynamic switch of PUCCH sSCell MAC CE command to activate PSCell as PUCCH sSCell for all the cells configured as part of SCG.

Then, SCellN UCI is sent over PSCell (i.e., PUCCH sSCell) or on SCellN, as indicated in DCI for dynamic configuration or pucch-sSCellPattern in RRC message for semi-static configuration. Similarly, SCell1 UCI is sent over PSCell (i.e., PUCCH sSCell) or on SCell1, as indicated in DCI for dynamic configuration or pucch-sSCellPattern in RRC message for semi-static configuration. Because the PSCell is configured as PUCCH sSCell for the cell group, all UCI feedback for PSCell will be sent over PSCell only.

Next, SCell1 becomes better candidate to serve as the PUCCH sSCell compared to the PSCell, based on defined criteria for the SCG. The dynamic switch of PUCCH sSCell MAC CE is triggered to deactivate PSCell as the PUCCH sSCell followed by one more dynamic switch of PUCCH sSCell MAC CE to activate SCell1 as the PUCCH sSCell for the SCG.

Accordingly, SCellN UCI is sent over SCell1 (i.e., PUCCH sSCell) or on SCellN, as indicated in DCI for dynamic configuration or pucch-sSCellPattern in RRC message for semi-static configuration. Similarly, PSCell UCI is sent over SCell1 (i.e., PUCCH sSCell) or on PSCell, as indicated in DCI for dynamic configuration or pucch-sSCellPattern in RRC message for semi-static configuration. As SCell1 is configured as PUCCH sSCell for the cell group, all UCI feedback for SCell1 will be sent over SCell1 only.

When none of the cell satisfies criteria to serve as PUCCH sSCell for the SCG, the gNB MAC triggers the dynamic switch of PUCCH sSCell MAC CE to deactivate PUCCH sSCell (i.e., SCell1). Thus, all UCI for each cell will be sent over cell as indicated by RRC, i.e., UCI information for each cell will be sent over same cell.

FIG. 15 and FIG. 16 show, respectively, a process 1500 and a process 1600 to dynamically switch PUCCH sSCell in a primary PUCCH group and a secondary PUCCH group. Dynamic switch of PUCCH sSCell MAC CE will be triggered separately within a cell group for each PUCCH group if configured by the gNB and supported by the UE.

FIG. 15 shows that, initially, the UE sends UCI information for each cell over the same cell, i.e., PCell UCI is sent over PCell, SCell1 UCI is sent over SCell1, and SCell2 UCI is sent over SCell2, as both SCell1 and SCell2 are PUCCH SCell. Now, criteria hits for triggering the dynamic switch of PUCCH sSCell MAC CE activation for the primary PUCCH group. The gNB MAC triggers the dynamic switch of PUCCH sSCell MAC CE command to activate PCell as PUCCH sSCell for all the cells configured as part of primary PUCCH group.

Then, SCell2 UCI is sent over PCell (i.e., PUCCH sSCell) or on SCell2, as indicated in DCI for dynamic configuration or pucch-sSCellPattern in RRC message for semi-static configuration. Similarly, SCell1 UCI is sent over PCell (i.e., PUCCH sSCell) or on SCell1 as indicated in DCI for dynamic configuration or pucch-sSCellPattern in RRC message for semi-static configuration. As PCell is configured as PUCCH sSCell for the primary PUCCH group so all UCI feedback for PCell will be sent over PCell only.

Next, SCell1 becomes better candidate to serve PUCCH sSCell compared to PCell, based on defined criteria for the primary PUCCH group. The dynamic switch of PUCCH sSCell MAC CE is triggered to deactivate PCell as PUCCH sSCell followed by one more dynamic switch of PUCCH sSCell MAC CE to activate SCell1 as PUCCH sSCell for the primary PUCCH group.

Accordingly, SCell2 UCI is sent over SCell1 (i.e., PUCCH sSCell) or on SCell2 as indicated in DCI for dynamic configuration or pucch-sSCellPattern in RRC message for semi-static configuration. Similarly, PCell UCI is sent over SCell1 (i.e., PUCCH sSCell) or on PCell as indicated in DCI for dynamic configuration or pucch-sSCellPattern in RRC message for semi-static configuration. As SCell1 is configured as PUCCH sSCell for the primary PUCCH group so all UCI feedback for SCell1 will be sent over SCell1 only.

When none of the cell satisfies criteria to serve as PUCCH sSCell for the PUCCH group, the gNB MAC triggers the dynamic switch of PUCCH sSCell MAC CE to deactivate PUCCH sSCell, i.e., SCell1. All UCI for each cell will be sent on the cell indicated by RRC, i.e., UCI information for each cell will be sent over same cell.

FIG. 16 shows that, initially, the UE sends UCI information for each cell over the same cell, i.e., SCell3 UCI is sent over SCell3, SCell4 UCI is sent over SCell4 and SCell5 UCI is sent over SCell5 (as both SCell4 and SCell5 are PUCCH SCells). Now, criteria hits for triggering dynamic switch of PUCCH sSCell MAC CE activation for the secondary PUCCH group. The gNB MAC triggers the dynamic switch of PUCCH sSCell MAC CE command to activate SCell3 as PUCCH sSCell for all the cells configured as part of the secondary PUCCH group.

Then, SCell5 UCI is sent over SCell3 (i.e., PUCCH sSCell) or on SCell5, as indicated in DCI for dynamic configuration or pucch-sSCellPattern in RRC message for semi-static configuration. Similarly, SCell4 UCI is sent over SCell3 (i.e., PUCCH sSCell) or on SCell4, as indicated in DCI for dynamic configuration or pucch-sSCellPattern in RRC message for semi-static configuration. As SCell3 is configured as PUCCH sSCell for the secondary PUCCH group, all UCI feedback for SCell3 will be sent over SCell3 only.

Next, SCell4 becomes better candidate to serve PUCCH sSCell than SCell3 based on defined criteria for the secondary PUCCH group. Dynamic switch of PUCCH sSCell MAC CE is triggered to deactivate SCell3 as PUCCH sSCell followed by one more dynamic switch of PUCCH sSCell MAC CE to activate SCell4 as PUCCH sSCell for the secondary PUCCH group.

Then, SCell5 UCI is sent over SCell4 (i.e., PUCCH sSCell) or on SCell5 as indicated in DCI for dynamic configuration or pucch-sSCellPattern in RRC message for semi-static configuration. Similarly, SCell3 UCI is sent over SCell4 (i.e., PUCCH sSCell) or on SCell3 as indicated in DCI for dynamic configuration or pucch-sSCellPattern in RRC message for semi-static configuration. As SCell4 is configured as PUCCH sSCell for the secondary PUCCH group, all UCI feedback for SCell4 will be sent over SCell4 only.

When none of the cell satisfies criteria to serve as PUCCH sSCell for the PUCCH group, the gNB MAC triggers the dynamic switch of PUCCH sSCell MAC CE to deactivate PUCCH sSCell, i.e., SCell4. All UCI for each cell will be sent on cell as indicated by RRC, i.e., UCI information for each cell will be sent over same cell.

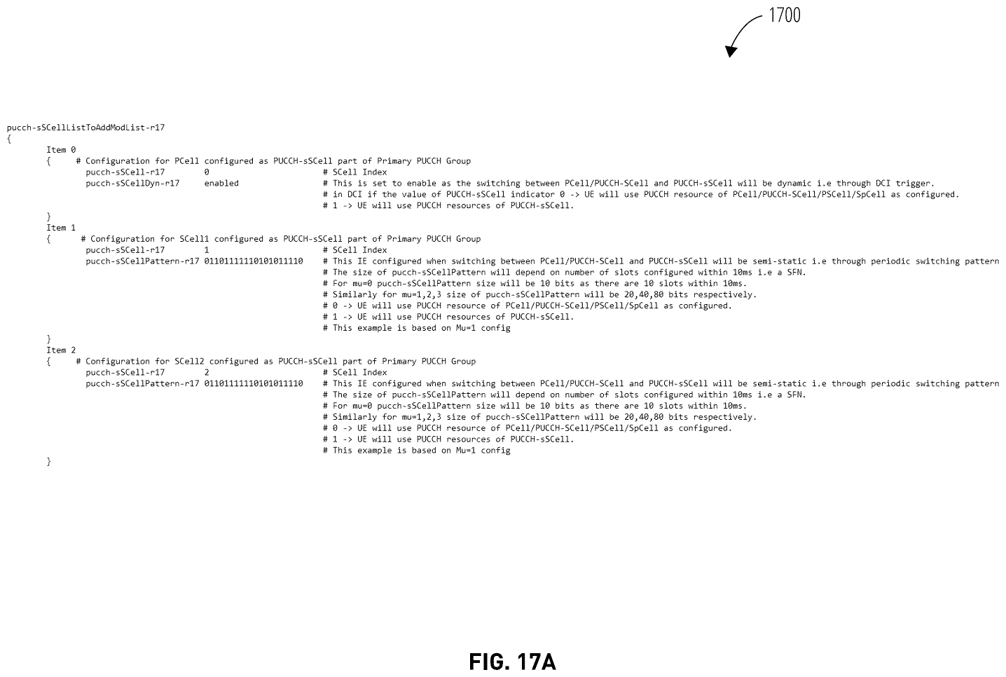

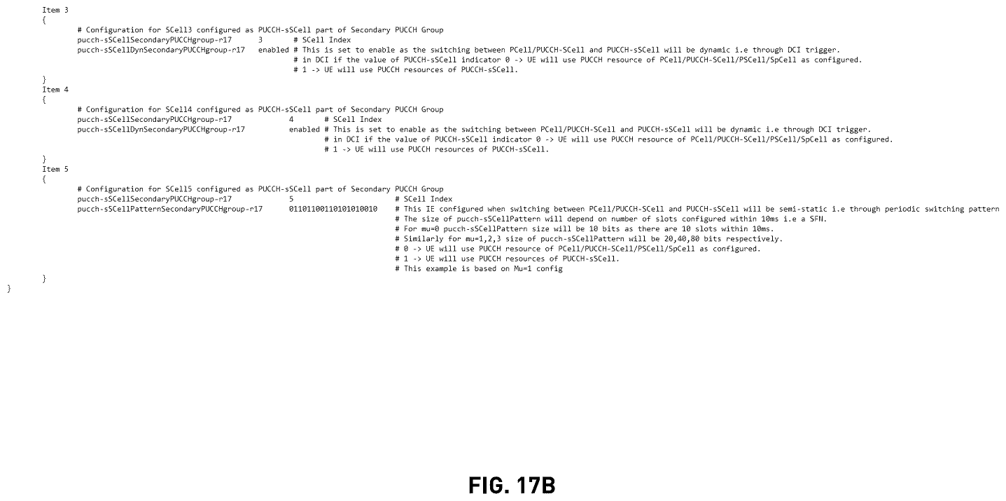

FIG. 17A and FIG. 17B show a pucch-sSCellListToAddModList-r17 configuration 1700 for FIG. 15 and FIG. 16 in which the PCell, SCell1, and SCell2 are part of the primary PUCCH group and SCell3, SCell4, and SCell5 are part of the secondary PUCCH group.

For the PCell, pucch-sSCellDyn-r17 is configured indicating a DCI based switching supported between RRC configured PUCCH cell and PUCCH sSCell. In DCI if the value of PUCCH sSCell indicator set to zero, then the UE will use PUCCH resource of RRC configured cell for transmission of HARQ feedback, i.e., same cell as per FIG. 15. When the PUCCH sSCell indicator set to one, then the UE will use PUCCH resources of PUCCH sSCell to transmit HARQ feedback, i.e., PCell as per FIG. 15.

For SCell1 and SCell2, pucch-sSCellPattern-r17 is configured indicating a periodic switching pattern between RRC configured PUCCH cell and PUCCH sSCell. If a bit value in pucch-sSCellPattern-r17 is set to zero, it indicates the UE will use RRC configured PUCCH resources for transmission of UCI feedback in the mapped slot, i.e., same cell as per FIG. 15. For bit value set to one in pucch-sSCellPattern-r17, the UE will use PUCCH sSCell, PUCCH resources for transmission of UCI feedback in the mapped slot, i.e., SCell1 as per FIG. 15.

For SCell3 and SCell4, pucch-sSCellDyn-r17 is configured indicating a DCI based switching supported between RRC configured PUCCH cell and PUCCH sSCell. In DCI if the value of PUCCH sSCell indicator set to zero, then the UE will use PUCCH resource of RRC configured cell for transmission of HARQ feedback, i.e., same cell as per FIG. 16. When the PUCCH sSCell indicator is set to one, then the UE will use PUCCH resources of PUCCH sSCell to transmit HARQ feedback, i.e., SCell3 or SCell4 as per FIG. 16.

For SCell5, pucch-sSCellPattern-r17 is configured indicating a periodic switching pattern between RRC configured PUCCH cell and PUCCH sSCell. If a bit value in pucch-sSCellPattern-r17 is set to zero, it indicates the UE will use RRC configured PUCCH resources for transmission of UCI feedback in the mapped slot. And for bit value set to one in pucch-sSCellPattern-r17, the UE will use PUCCH sSCell, PUCCH resources for transmission of UCI feedback in the mapped slot.

The size of pucch-sSCellPattern will depend on number of slots configured within 10 ms, i.e., a SFN. For mu=0, pucch-sSCellPattern size will be 10 bits as there are 10 slots within. Similarly, for mu=1, 2, 3, the size of pucch-sSCellPattern will be 20, 40, 80 bits respectively. In FIG. 17A and FIG. 17B, the pucch-sSCellPattern is defined according to mu=1 subcarrier spacing.

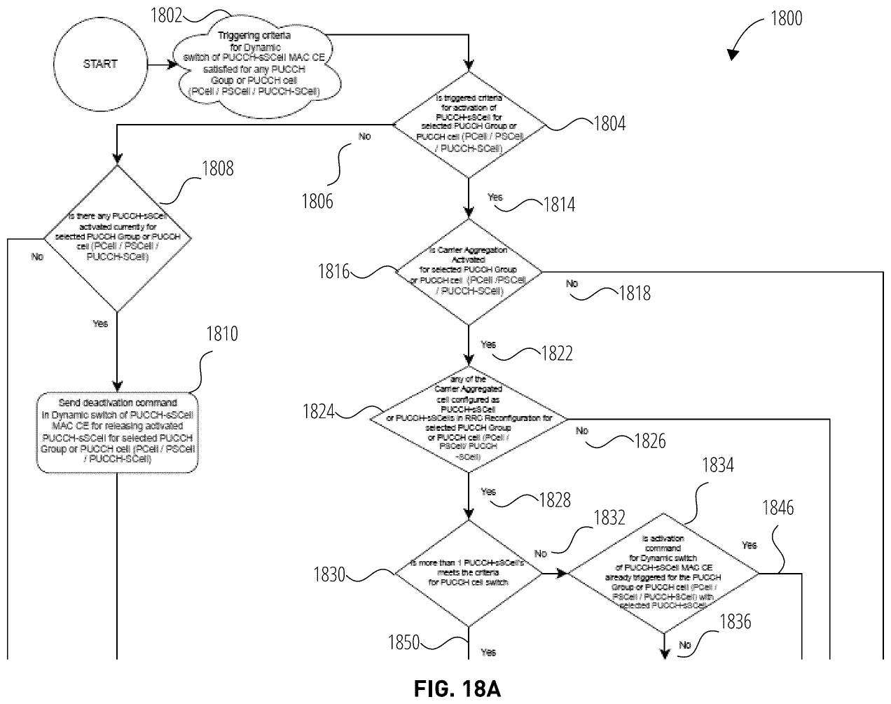

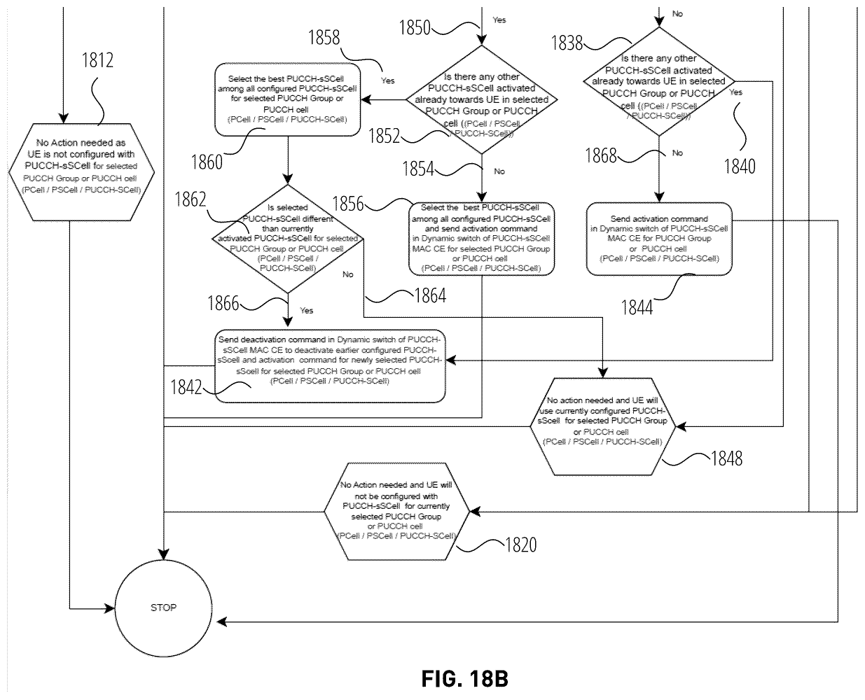

FIG. 18A and FIG. 18B shows a process for dynamic switch of a PUCCH sSCell. A gNB will check 1802 for triggering criteria mentioned earlier for determining if dynamic switch of PUCCH sSCell MAC CE is satisfied for any of the PUCCH group, cell group, or cell (depending on the configuration). (For conciseness, FIG. 18A and FIG. 18B do not mention a switch in the cell group, although that is an option described above. Likewise, they do not show “SpCell” in each instance) In case a PUCCH group is not configured, then PUCCH cell switch will be checked and triggered for individual cells (PUCCH SCell and PCell/PSCell/SpCell). Dynamic switch of PUCCH sSCell MAC CE will be triggered separately for each cell group (MCG and SCG), for each PUCCH group (primary PUCCH group and secondary PUCCH group), for each cell (PUCCH SCell and PCell/PSCell/SpCell).

Initially, the gNB will check 1804 whether the triggered dynamic switch of PUCCH sSCell MAC CE is for activation or deactivation. In case of deactivation 1806, the gNB will check 1808 whether the dynamic switch of PUCCH sSCell MAC CE already activated towards the UE for selected PUCCH group, cell group, or PUCCH cell (PUCCH SCell and PCell/PSCell/SpCell).

If the dynamic switch of PUCCH sSCell MAC CE is already activated, then deactivation will be triggered to release 1810 the configured PUCCH sSCell. In case there is no PUCCH sSCell is activated towards the UE for selected PUCCH group, cell group, or PUCCH cell (PUCCH SCell and PCell/PSCell) then there will be no action 1812 (FIG. 18B) is needed, as UE is not configured with PUCCH sSCell.

If received dynamic switch of PUCCH sSCell MAC CE is for activation 1814 (FIG. 18A) of PUCCH sSCell, then the gNB will check 1816 whether carrier aggregation (CA) is already activated across mentioned cells (since without activation of CA, the PUCCH cell switching to a PUCCH sSCell not supported). If CA is not activated 1818, then PUCCH sSCell will not be configured 1820 (FIG. 18B) towards the UE.

If CA is already activated 1822 (FIG. 18A) across the aforementioned cells, then the gNB will check 1824 among all configured CCs, which are the cells configured with PUCCH sSCell in RRC reconfiguration. In case if none of the cell currently activated 1826 as part of CA is present in RRC reconfiguration indicating PUCCH sSCell, then PUCCH sSCell will not be configured 1820 (FIG. 18B) towards the UE.

If some of the activated cells in CA are already configured 1828 (FIG. 18A) as PUCCH sSCell in RRC reconfiguration, then the gNB will check 1830 for number of cells with configured PUCCH sSCell. If number of configured PUCCH sSCell is one cell 1832, then the gNB will check 1834 whether there was any activation command for the dynamic switch of PUCCH sSCell MAC CE already triggered for the PUCCH group, cell group, or PUCCH cell (PCell/PSCell/SpCell/PUCCH SCell) for the same PUCCH sSCell.

If the dynamic switch of PUCCH sSCell MAC CE is not already triggered 1836 for the PUCCH group, cell group, or PUCCH cell (PCell/PSCell/SpCell/PUCCH SCell) for same PUCCH sSCell, then the gNB will check 1838 whether there was any other PUCCH sSCell activated already towards the UE for selected PUCCH group, cell group, or PUCCH cell (PCell/PSCell/SpCell/PUCCH SCell).

If there was already the dynamic switch of PUCCH sSCell MAC CE activation triggered 1840 towards the UE with other PUCCH sSCell, then gNB will send deactivation 1842 command in the dynamic switch of PUCCH sSCell MAC CE to release currently configured PUCCH sSCell and trigger activation of dynamic switch of PUCCH sSCell MAC CE for newly selected PUCCH sSCell.

If there was no dynamic switch of PUCCH sSCell MAC CE already triggered for selected PUCCH group, cell group, or PUCCH cell (PCell/PSCell/SpCell/PUCCH SCell), then the gNB will directly trigger 1844 the dynamic switch of PUCCH sSCell MAC CE in order to activate PUCCH sSCell.

If currently selected PUCCH sSCell already activated 1846 (FIG. 18A) towards the UE in the dynamic switch of PUCCH sSCell MAC CE, then no action is needed at the gNB, The UE will use currently configured 1848 (FIG. 18B) PUCCH sSCell for selected PUCCH group, cell group, or PUCCH cell (PCell/PSCell/SpCell/PUCCH SCell).

In case if there were multiple PUCCH sSCell which are configured 1850 in RRC reconfiguration meeting the criteria for PUCCH cell switch, then the gNB will determine 1852 whether any other PUCCH sSCell is already configured towards the UE.

If there was no dynamic switch of PUCCH sSCell MAC CE already triggered 1854 for selected PUCCH group, cell group, or PUCCH cell (PCell/PSCell/SpCell/PUCCH SCell), then the gNB will select 1856 the best PUCCH sSCell based on defined criteria among all configured PUCCH sSCell and trigger the dynamic switch of PUCCH sSCell MAC CE in order to activate selected best PUCCH sSCell towards the UE.

In case there was a dynamic switch of PUCCH sSCell MAC CE already activated 1858 towards the UE, then the gNB will select 1860 the best PUCCH sSCell among all configured PUCCH sSCell for selected PUCCH group, cell group, or PUCCH cell (PCell/PSCell/SpCell/PUCCH SCell).

Once the best PUCCH sSCell determined, the gNB will compare 1862 whether the selected best PUCCH sSCell is different than currently activated PUCCH sSCell towards the UE. If currently selected best PUCCH sSCell is same 1864 as PUCCH sSCell which was already activated towards the UE, then no action needed at the gNB, and UE will use currently configured 1848 PUCCH sSCell for selected PUCCH group, cell group, or PUCCH cell (PCell/PSCell/SpCell/PUCCH SCell).

In case the currently selected best PUCCH sSCell is different 1866 than the currently activated PUCCH sSCell towards the UE, then the gNB will send deactivation 1842 command in the dynamic switch of PUCCH sSCell MAC CE to release currently configured PUCCH sSCell and trigger activation of the dynamic switch of PUCCH sSCell MAC CE for newly selected best PUCCH sSCell towards the UE.

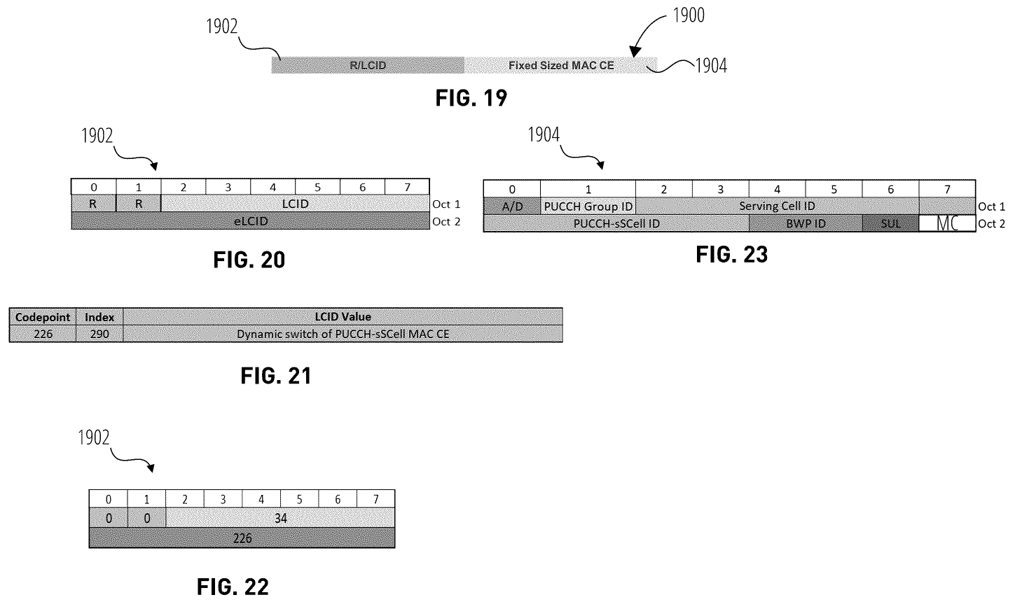

FIG. 19 shows that the dynamic switch of PUCCH sSCell MAC CE 1900 has total size of four octets, including a sub header structure 1902 (see, e.g., FIG. 20-FIG. 22) and MAC CE data 1904 (see, e.g., FIG. 23).

FIG. 20 shows the MAC sub header structure for the dynamic switch of PUCCH sSCell MAC CE. The sub header will have a fixed size of two octets with following content, in some embodiments.

R-two bits: Reserved for future use (bit set to zero). The R would be 1 bit if two PUCCH groups are not defined or else it will be of 0 bits.

LCID-six bits: The Logical Channel ID field identifies the logical channel instance of the corresponding MAC SDU or the type of the corresponding MAC CE or padding as described in TS 38.321. If the LCID field is set to 34, one additional octet is present in the MAC sub header containing the eLCID field and follow the octet containing LCID field. If the LCID field is set to 33, two additional octets are present in the MAC sub header containing the eLCID field and these two additional octets follow the octet containing LCID field. For the dynamic switch of PUCCH sSCell MAC CE value will be set to 34.

eLCID-eight bits: The extended Logical Channel ID field identifies the logical channel instance of the corresponding MAC SDU, or the type of the corresponding MAC CE as described in TS 38.321 for the DL-SCH and UL-SCH respectively. The size of the eLCID field is either eight bits or 16 bits. For the dynamic switch of PUCCH sSCell MAC CE value will be set to as shown in FIG. 21 and FIG. 22. FIG. 21 and FIG. 22 are just examples, however, and the codepoint and index value would be defined based on available data set in the standards avoiding conflicts.

After including the values described in FIG. 21, the MAC sub header for the dynamic switch of PUCCH sSCell MAC CE has the values shown in FIG. 22.

FIG. 23 shows a MAC CE message definition for triggering the dynamic switch of PUCCH sSCell MAC CE when multiple PUCCH group are configured. The dynamic switch of PUCCH sSCell MAC CE will have a fixed size of two octets with following content, in some embodiments.

A/D-one bit: If set to the value one it will activate PUCCH sSCell and the value zero indicates deactivation of PUCCH sSCell.

PUCCH group ID-one bit: Indicates if the dynamic switch of PUCCH MAC CE for primary PUCCH group or secondary PUCCH group. The value of zero indicates the primary PUCCH group and the value of one indicates the secondary PUCCH group. This field will be left reserved if multiple PUCCH group are not configured. When multiple PUCCH group are not configured towards the UE by the gNB, or if the UE does not support multiple PUCCH groups, then PUCCH group ID will be configured as reserved.

Serving Cell ID-five bits: Indicates for which serving cell PUCCH sSCell switch is activated and PUCCH sSCell is configured. In current specification maximum 32 cell CA is supported so the size of Serving Cell ID is configured with five bits. In case activation is triggered per cell group, then PCell Serving Cell ID value will be indicated in Serving Cell ID. For MCG and SCG, Serving Cell ID value will be set to SpCell and PSCell Serving Cell ID respectively. For primary PUCCH group, Serving Cell ID value will be set to PCell Serving Cell ID and for secondary PUCCH group, Serving Cell ID value will be set to any PUCCH SCell Serving Cell ID part of the secondary PUCCH group.

PUCCH sSCell ID-five bits: Indicates the SCell index to be used for PUCCH sSCell. The UE will have option to send PUCCH on PUCCH sSCell or to the configured PCell/PSCell/SpCell/PUCCH SCell. In current specification maximum 32 cell CA is supported so the size of PUCCH sSCell ID is configured with five bits.

BWP ID-two bits: Indicates the BWP ID to be used within PUCCH sSCell if multiple BWP are configured. There can be maximum for BWP possible hence size of two bits.

SUL-one bit: Indicate if PUCCH sSCell ID is configured with a supplementary uplink (SUL). If field is set to the value of one then on PUCCH-sSCell the UE will use configured SUL to send PUCCH when PUCCH cell switch is triggered, and when field is set to the value zero it will use normal uplink.

Multi-cell configuration-one bit: The value of one indicates PUCCH sSCell within MAC CE is applicable across all cells within the cell group. The value of zero indicates configured PUCCH sSCell within MAC CE is only applicable to cells indicated in Serving Cell ID.

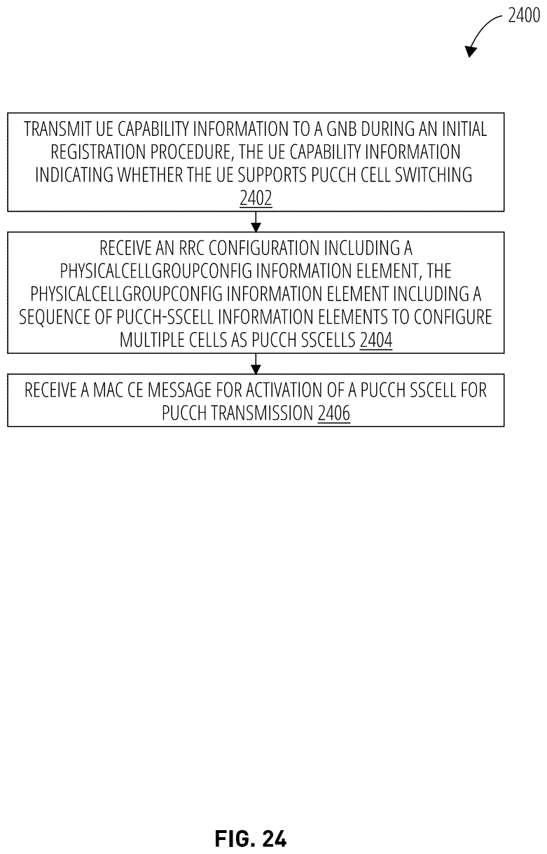

FIG. 24 shows a process 2400, performed by a UE, of PUCCH sSCell switching. In block 2402, process 2400 transmits UE capability information to a gNB during an initial registration procedure, the UE capability information indicating whether the UE supports PUCCH cell switching. In block 2404, process 2400 receives an RRC configuration including a PhysicalCellGroupConfig information element, the PhysicalCellGroupConfig information element including a sequence of pucch-sSCell information elements to configure multiple cells as PUCCH sSCells. In block 2406, process 2400 receives a MAC CE message for activation of a PUCCH sSCell for PUCCH transmission.

Process 2400 may also include switching the PUCCH sSCell from a first cell to a second cell by deactivation of the first cell identified in a first MAC CE message and activation of the second cell identified in a second MAC CE message.

Process 2400 may also include the deactivation performed after a time delay that is based on subcarrier spacing and PDSCH-to-HARQ_feedback timing indicator.

Process 2400 may also include the activation being for an individual cell, a PUCCH group, or a cell group.

Process 2400 may also include the sequence of pucch-sSCell information elements having a first pucch sSCell information element for a primary PUCCH group, and a secondary pucch-sSCell information element for a secondary PUCCH group.

Process 2400 may also include the sequence of pucch-sSCell information elements being a first sequence of pucch-sSCell information elements for a master cell group, and a second sequence of pucch-sSCell information elements being for a secondary cell group.

Process 2400 may also include selecting an RRC configured PUCCH cell for a first transmission and selecting the PUCCH sSCell for a second transmission.

Process 2400 may also include the selecting being based on a predetermined periodic cell switch pattern.

Process 2400 may also include the selecting being based on a DCI indicator.

Process 2400 may also include the activation performed after a time delay that is based on subcarrier spacing and PDSCH-to-HARQ_feedback timing indicator.

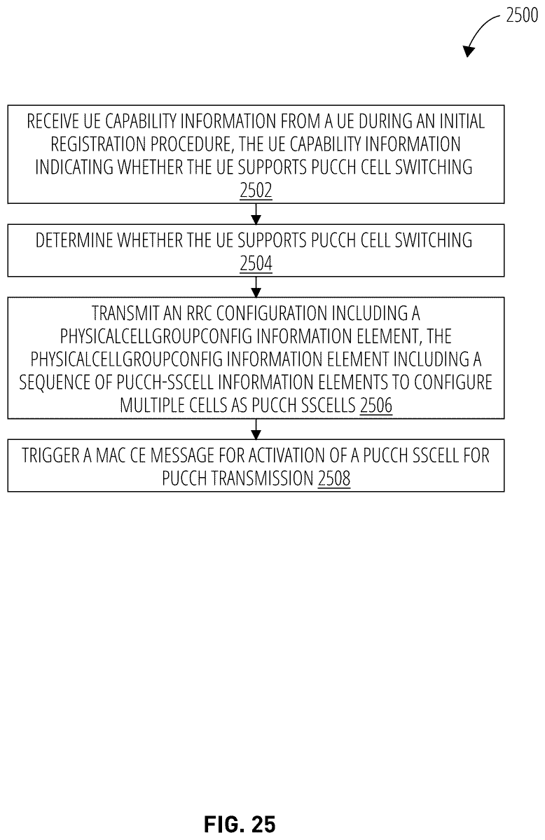

FIG. 25 shows a process 2500, performed by a gNB, of PUCCH sSCell switching. In block 2502, process 2500 receives UE capability information from a UE during an initial registration procedure, the UE capability information indicating whether the UE supports PUCCH cell switching. In block 2504, process 2500 determines whether the UE supports PUCCH cell switching. In block 2506, process 2500 transmits an RRC configuration including a PhysicalCellGroupConfig information element, the PhysicalCellGroupConfig information element including a sequence of pucch-sSCell information elements to configure multiple cells as PUCCH sSCells. In block 2508, process 2500 triggers a MAC CE message for activation of a PUCCH sSCell for PUCCH transmission.

Process 2500 may also include the PUCCH sSCell being for an FDD system.

Process 2500 may also include the PUCCH sSCell being for an TDD system.

Process 2500 may also include the sequence of pucch-sSCell information elements having a first pucch-sSCell information element for a primary PUCCH group, and a second pucch-sSCell information element for a secondary PUCCH group.

Process 2500 may also include the sequence of pucch-sSCell information elements having a first sequence of pucch-sSCell information elements for a master cell group, and in which a second sequence of pucch-sSCell information elements is for a secondary cell group.

Process 2500 may also include the PhysicalCellGroupConfig information element configuring the UE for PUCCH cell switching that is statically configured based on a predetermined periodic cell switch pattern.

Process 2500 may also include the PhysicalCellGroupConfig information element configuring the UE for PUCCH cell switching that is dynamically configured based on a DCI indicator.

Process 2500 may also include selecting a PUCCH sSCell from among the configured PUCCH sSCells based on one or more triggering criteria, the one or more triggering criteria including pathloss, PUCCH resource location in a resource grid, block error rate, load on cell, cross fronthaul deployment type, selected antenna port, configured PUCCH sSCell switch pattern, or type of spectrum used.

Process 2500 may also include the MAC CE message is a first MAC CE message, and process 2500 further includes switching the selected PUCCH sSCell by deactivation of a first cell identified in the first MAC CE message and activation of a second cell identified in a second MAC CE message.

Process 2500 may also include deactivating the PUCCH sSCell in response to none of the cells qualifying as the PUCCH sSCell based on one or more triggering criteria.

Process 2500 may also include, in response to the activation or deactivation performed after a time delay that is based on subcarrier spacing and PDSCH-to-HARQ_feedback timing indicator, and monitoring PUCCH on both RRC configured celles and the PUCCH sSCells.

Process 2500 may also include triggering a deactivation MAC CE message to deactivate the PUCCH sSCell preparatory to a cell release.

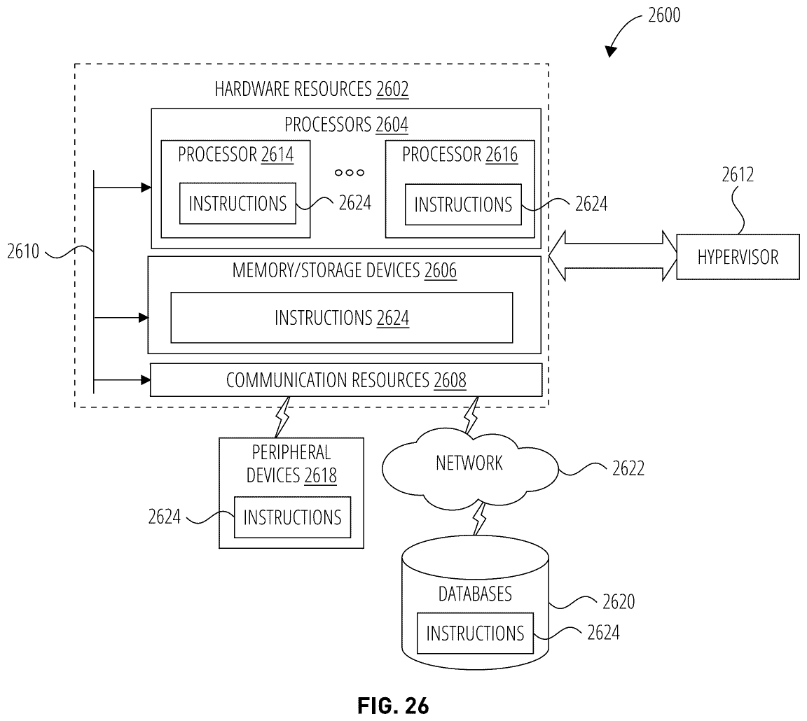

FIG. 26 is a block diagram illustrating components 2600, according to some example embodiments, configured to read instructions from a machine-readable or computer-readable medium (e.g., a non-transitory machine-readable storage medium) and perform any one or more of the methods discussed herein (or portions thereof), such as discussed for process 800 (FIG. 8), process 1000 (FIG. 10), process 1200 (FIG. 12), process 1300 (FIG. 13), process 1400 (FIG. 14), process 1500 (FIG. 15), process 1600 (FIG. 16), process 1800 (FIG. 18A and FIG. 18B), process 2400 (FIG. 24), or process 2500 (FIG. 25).

Specifically, FIG. 26 shows a diagrammatic representation of hardware resources 2602 including one or more processors 2604 (or processor cores), one or more memory/storage devices 2606, and one or more communication resources 2608, each of which may be communicatively coupled via a bus 2610. For embodiments where node virtualization (e.g., NFV) is utilized, a hypervisor 2612 may be executed to provide an execution environment for one or more network slices/sub-slices to utilize hardware resources 2602.

Processors 2604 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio frequency integrated circuit (RFIC), another processor, or any suitable combination thereof) may include, for example, a processor 2614 and a processor 2616.

Memory/storage devices 2606 may include main memory, disk storage, or any suitable combination thereof. Memory/storage devices 2606 may include, but are not limited to, any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

Communication resources 2608 may include interconnection or network interface components or other suitable devices to communicate with one or more peripheral devices 2618 or one or more databases 2620 via a network 2622. For example, communication resources 2608 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2624 may comprise software, a program, an application, an applet, an app, or other executable code for causing at least any of processors 2604 to perform any one or more of the methods discussed herein. Instructions 2624 may reside, completely or partially, within at least one of processors 2604 (e.g., within the processor's cache memory), memory/storage devices 2606, or any suitable combination thereof. Furthermore, any portion of instructions 2624 may be transferred to hardware resources 2602 from any combination of peripheral devices 2618 or databases 2620. Accordingly, the memory of processors 2604, memory/storage devices 2606, peripheral devices 2618, and databases 2620 are examples of computer-readable and machine-readable media.

In light of this disclosure, skilled persons will appreciate that many changes may be made to the details of the above-described embodiments without departing from the underlying principles of the invention. The scope of the present invention should, therefore, be determined only by claims and equivalents.

What is claimed is:

1. A method, performed by a UE, of PUCCH sSCell switching, the method comprising:
transmitting UE capability information to a gNB during an initial registration procedure, the UE capability information indicating whether the UE supports PUCCH cell switching;
receiving an RRC configuration including a PhysicalCellGroupConfig information element, the PhysicalCellGroupConfig information element including a sequence of pucch-sSCell information elements to configure multiple cells as PUCCH sSCells; and
receiving a MAC CE message for activation of a PUCCH sSCell for PUCCH transmission.

2. The method of claim 1, further comprising switching the PUCCH sSCell from a first cell to a second cell by deactivation of the first cell identified in a first MAC CE message and activation of the second cell identified in a second MAC CE message.

3. The method of claim 2, in which the deactivation is performed after a time delay that is based on subcarrier spacing and PDSCH-to-HARQ_feedback timing indicator.

4. The method of claim 1, in which the activation is for an individual cell, a PUCCH group, or a cell group.

5. The method of claim 1, in which the sequence of pucch-sSCell information elements includes a first pucch sSCell information element for a primary PUCCH group, and a secondary pucch-sSCell information element is for a secondary PUCCH group.

6. The method of claim 1, in which the sequence of pucch-sSCell information elements is a first sequence of pucch-sSCell information elements for a master cell group, and in which a second sequence of pucch-sSCell information elements is for a secondary cell group.

7. The method of claim 1, further comprising selecting an RRC configured PUCCH cell for a first transmission and selecting the PUCCH sSCell for a second transmission.

8. The method of claim 7, in which the selecting is based on a predetermined periodic cell switch pattern.

9. The method of claim 7, in which the selecting is based on a DCI indicator.

10. The method of claim 1, in which the activation is performed after a time delay that is based on subcarrier spacing and PDSCH-to-HARQ_feedback timing indicator.

11. A method, performed by a gNB, of PUCCH sSCell switching, the method comprising:
receiving UE capability information from a UE during an initial registration procedure, the UE capability information indicating whether the UE supports PUCCH cell switching;
determining whether the UE supports PUCCH cell switching;
transmitting an RRC configuration including a PhysicalCellGroupConfig information element, the PhysicalCellGroupConfig information element including a sequence of pucch-sSCell information elements to configure multiple cells as PUCCH sSCells; and
triggering a MAC CE message for activation of a PUCCH sSCell for PUCCH transmission.

12. The method of claim 11, in which the PUCCH sSCell is for an FDD system.

13. The method of claim 11, in which the PUCCH sSCell is for an TDD system.

14. The method of claim 11, in which the sequence of pucch-sSCell information elements includes a first pucch-sSCell information element for a primary PUCCH group, and a second pucch-sSCell information element is for a secondary PUCCH group.

15. The method of claim 11, in which the sequence of pucch-sSCell information elements is a first sequence of pucch-sSCell information elements for a master cell group, and in which a second sequence of pucch-sSCell information elements is for a secondary cell group.

16. The method of claim 11, in which the PhysicalCellGroupConfig information element configures the UE for PUCCH cell switching that is statically configured based on a predetermined periodic cell switch pattern.

17. The method of claim 11, in which the PhysicalCellGroupConfig information element configures the UE for PUCCH cell switching that is dynamically configured based on a DCI indicator.

18. The method of claim 11, further comprising selecting a PUCCH sSCell from among the configured PUCCH sSCells based on one or more triggering criteria, the one or more triggering criteria including pathloss, PUCCH resource location in a resource grid, block error rate, load on cell, cross fronthaul deployment type, selected antenna port, configured PUCCH sSCell switch pattern, or type of spectrum used.

19. The method of claim 18, in which the MAC CE message is a first MAC CE message, and the method further comprising switching the selected PUCCH sSCell by deactivation of a first cell identified in the first MAC CE message, and activation of a second cell identified in a second MAC CE message.

20. The method of claim 18, further comprising deactivating the PUCCH sSCell in response to none of the cells qualifying as the PUCCH sSCell based on one or more triggering criteria.

21. The method of claim 11, further comprising, in response to the activation or deactivation performed after a time delay that is based on subcarrier spacing and PDSCH-to-HARQ_feedback timing indicator, and monitoring PUCCH on both RRC configured cells and the PUCCH sSCells.

22. The method of claim 11, further comprising triggering a deactivation MAC CE message to deactivate the PUCCH sSCell preparatory to a cell release.
